(19) United States
(12) Patent Application Publication
(10) Pub. No.: US 2004/0002386 A1
(43) Pub. Date: Jan. 1, 2004

(54) Wireless casino information management system and method

(75) Inventors: Jon Christian Wolfe, Las Vegas, NV (US); Kevin Lee Byrd, Olive Branch, MS (US)

Correspondence Address: Rachel L. St. Peter, ICE MILLER, One American Square, Box 82001, Indianapolis, IN, 46282-0002, US

(73) Assignee: Horseshoe Gaming Holding Corp., Las Vegas, NV

(21) Appl. No.: 10/608,827

(22) Filed: Jun. 27, 2003

Related U.S. Application Data
(60) Provisional application No. 60/392,702, filed on Jun. 27, 2002.

(51) Int. Cl. G06F 19/00; G06F 17/00; A63F 13/00; A63F 9/24; G06F 17/60

(52) U.S. Cl. 463/42; 463/40; 705/1

(57) ABSTRACT

A wireless casino information management system and method for conducting casino business at any location within a casino. The system includes a host server having a memory, a database associated with the memory, data relative to the casino business stored in the memory in accordance with the database, at least one handheld computing device capable of being transported to any location within the casino, and a wireless communication system operably coupled between the host server and the handheld computing device, the wireless communication system configured for bi-directional communication of the casino business data between the host server and the handheld computing device. The method for conducting casino business at any location within a casino includes the steps of establishing bi-directional wireless communication between the host server and the handheld computer device, and communicating the casino business data between the host server and the handheld computing device.

### CROSS REFERENCE TO RELATED APPLICATIONS

This application claims the benefit of U.S. Provisional Application No. 60/392,702 filed Jun. 27, 2002.

### BACKGROUND

The casino industry is one of the most profitable industries in the United States today. Casinos gross billions of dollars every year. As a result, the casino industry is also an extremely competitive industry. To illustrate the competitiveness of the casino industry, consider that casinos spend exorbitant amounts of money each year to “spy” on their competitors. Casino employees are given money to gamble at competing casinos in order to learn about the business practices of these competing casinos. As a result of the profitability and competitiveness of the casino industry, nearly all casinos collect, maintain, and process extensive information about their customers in order to identify and reward their valuable players so that the players remain loyal to a particular casino.

Further, the casino industry is highly regulated by numerous governmental agencies including, but not limited to the Internal Revenue Service (“IRS”) and state gaming commissions. In addition, as large amounts of money are constantly being processed at casinos, employee theft is a very common and expensive problem. For the additional reasons of compliance with the extensive gaming regulations and for internal security purposes, casinos must collect, maintain, and process extensive information related to both players and gaming machines. Although casinos collect, maintain, and process extensive information about their players and gaming machines for the reasons set forth above, prior art methods and systems for collecting, maintaining, and processing this information are inefficient and ineffective, costing casinos millions of dollars each year, as explained in more detail below.

In order to collect extensive player information, it is a well known practice in the casino industry for casinos to issue player's cards to players registered for the casinos' customer loyalty program(s). Currently, in the casino industry, in order to register for a customer loyalty program, the player must take time out from his or her gaming activities. Therefore, the casino loses money during the time period when the customer is signing up for the customer loyalty program instead of gambling. Further, some players will not take the time to register for a customer loyalty program because they do not wish to interrupt their gambling activities. Thus, the casino loses its opportunity to collect valuable information about its players in order to reward the players so that they will return to a particular casino. For this reason, it is desired to provide a method and system that allows the casino to enroll a player in a customer loyalty program at the customer's location while the player is gambling at a gaming machine or table.

Once the player is registered for a customer loyalty program and receives a player's card, the player inserts the card into a card reader associated with, among other devices and activities, gaming machines, such as slot machines. As is well known in the art, these cards allow the casino to track extensive information about a player, as well as the various activities in which a player participates at the casino.

One of the most important reasons why casinos collect information about a player is for utilization in their marketing efforts to develop a player's loyalty to a certain casino. Three main marketing methods exist in the casino industry for developing the player's loyalty to a particular casino. First, by using his or her player's card, the player accumulates points based on the player's activities at a particular casino. The player may then redeem his or her points for merchandise or services at the casino. Second, from the gambling information collected about players, casinos evaluate the worth of players to the casino. If the player's worth to the casino is sufficiently high, casino personnel may award the player a complimentary (referred to herein as a “comp”), such as free meals at casino restaurants, free event tickets, or free hotel rooms. Comping is a well known practice in the casino industry, and is one of the most effective practices in developing the loyalty of a player to a particular casino. Finally, it is also common in the casino industry to send players advertisements from the casino with a coupon associated therewith. The coupon may be for a certain amount of free gambling or a free night at a hotel. The coupon is usually bar coded.

Although casinos spend much time and money collecting and tracking player information, there are inefficiencies and inaccuracies associated with utilizing this information. First, with respect to the coupons directly mailed to a player, although the player cannot redeem the coupon unless the player brings the coupon to the casino, the player often forgets to bring the coupons to the casino. In addition, in order to redeem the coupon, the player must present the coupon at a player kiosk or customer service center located on the casino floor or at a cage on the casino floor. Thus, the time the player spends redeeming the coupon could better be spent gambling. Therefore, it is desired to provide a method and system for the redemption of the coupons at the player's location while the player is gambling, regardless of whether the player brought the actual coupon into the casino.

In addition, although casinos gather extensive information about players and gaming machines, it is cumbersome for casino personnel to access this information, especially for the purpose of awarding comps to the player. In conventional casino systems, several employee computer terminals are located on the casino floor. These employee computer terminals are hardwired to the casino's computer system and are static in location. The casino employee must leave the player's location and go to one of the employee computer terminals in order to access information about a particular player or machine. Such information includes, but is not limited to, general player and machine information, trip history information, table rating information, and comp evaluation information. If the player is eligible for a comp, the employee must also use an employee computer terminal in order to issue the comp. The employee must then return to the player's location in order to present the comp to the player.

This conventional method of accessing player and gaming machine information and conducting transactions based on that information has many disadvantages associated with it. For example, if an employee wishes to comp a player or if the player requests a comp, the employee must leave the player and go to the employee computer terminal in order to access the player's information to determine to what comp, if any, the player is entitled. As this process is time consuming, and the employee has been required to leave the player, the player may have left the casino or moved to another location in the casino. The employee has no way to locate the player except by searching the casino floor. Further, as this process is time consuming, it is both an inconvenience for casino employees and the player, who may be disappointed with the casino's responsiveness to his or her request for a comp. In addition, the employee computer terminals take up space on the casino floor that could be used for additional gaming machines or gaming tables that would increase the casino's revenues. These same disadvantages exist if the employee wishes to access player or gaming machine information for purposes other than comping a player, such as to resolve customer disputes over accumulated play or points. Therefore, it is desired to provide a method and system that allows a casino employee to retrieve extensive player and gaming machine information and perform transactions based upon that information at any location on the casino floor, including at the player's location, without utilizing casino floor space.

Although the use of the player's card is an effective means for gathering information about a player's gambling activity at gaming machines such as slot machines or video poker machines, the process of collecting information about a player's gambling activity at table games, such as poker or blackjack, is more difficult. For example, in one conventional casino system, floor personnel watch the player's gambling activities at a gaming table. After the player's gambling activity ceases, floor personnel then manually rate the player's performance at the table game on a piece of paper. This rating is known in the casino industry as a “table rating.” The table rating is then given to a pit clerk to manually enter the table rating into the casino's computer system at a remote employee computer terminal. A pit clerk must enter this data instead of the floor personnel who generated the table rating entering the data as the floor personnel must constantly monitor the table activity in order to accurately determine table ratings for players. The pit clerk may not enter the table ratings for several hours after the table gaming session ended if the casino is busy, such as on a weekend night. Thus, this manual system for collecting table ratings is time consuming and labor intensive as it involves at least two casino employees. Further, the casino's computer system may not have real time information about a player's gaming activity for the purpose of its marketing efforts. Thus, it is desired to provide a method and system that allows floor personnel to enter the table rating of a play immediately after observing a player's table play at the location of the table game.

Further, prior art systems do not leverage the information already collected about a player in order to streamline the process of complying with the requirements of the numerous governmental agencies regulating the casino industry. For example, casinos are required to provide the IRS with a Form W-2G if a player wins a certain amount of money from the casino. The information necessary to complete the Form W-2G includes the player's name, address, two types of identification, the player's nationality, the player's signature, and a photo of the player. Photos of players are also necessary for other regulatory purposes, as well as for internal security purposes. Although casinos currently collect at least some of the information needed to complete the Form W-2G, prior art systems require that employees return to the static employee casino terminal to either verify the information or to once again enter all necessary information about the patron, instead of simply verifying the player's existing information at the player's location. Further, after the employee uses the employee computer terminal to complete and print the Form W-2G, the employee must return to the player's location in order to obtain the player's signature. Again, this is a time consuming process and is inconvenient for both the casino employee and the player. The photo of the player is prepared from the surveillance cameras. It is also time consuming to locate surveillance camera footage of a particular player and match it with the player's Form W-2G information. Therefore, it is desired to provide a system and method for leveraging existing information about players at the player's location in order to comply with the requirements of regulatory agencies. It is also desired to provide a system and method of simultaneously capturing the player's photograph and signature.

Inefficiencies and inaccuracies also exist with regard to prior art systems and methods for collecting, maintaining, and processing the information related to gaming machines for compliance with government regulations and for the casino's own internal security purposes. Specifically, the inefficiencies and inaccuracies associated with prior art systems and methods for drop box, hopper fill and jackpot processing are discussed below.

A drop box is a bill validation unit that stores bills (contrasted with coins) that players insert into gaming machines in order to play the gaming machines. At certain time intervals, the drop boxes containing money (typically known as “hot boxes”) are removed from the gaming machines and empty, new drop boxes (typically known as “cold boxes”) are inserted into the gaming machines. Conventional gaming machines have electronic hard meters that constantly monitor the amount of money, both coins and bills, inserted into the gaming machine, as well as other information associated with the gaming machines, such as, for example, the number of games played on a gaming machine. A data collection device, sometimes referred to as a router or front end controller, polls this information from the machine meters at certain time intervals and this information is stored on the casino's databases. After the drop boxes are removed from the gaming machine, the metered value of the bills inserted into the machine is measured against the actual value of the bills in the drop box in order to track variances for security and tax purposes.

In one prior art system, each gaming machine has two drop boxes that are rotated. The drop boxes are numbered or uniquely marked in order to identify to which gaming machine the drop boxes belong. When the drop boxes for a particular machine are rotated, the casino employee holds the drop boxes up to a surveillance camera to ensure that the drop boxes are properly rotated. Monitoring the rotation of the drop boxes in this manner has many disadvantages. First, as the casino employees counting the bills in the drop boxes know which drop boxes belong to the more expensive gaming machines, these drop boxes are more susceptible to employee theft. Second, it is time consuming to review the video from the surveillance cameras to ensure that the drop boxes are properly rotated and a particular drop box was inserted into its corresponding gaming machine. Further, the quality of the surveillance videos may not allow for the proper identification of the drop boxes. In addition, drop boxes from one machine are inadvertently associated with a different machine during the counting process, thus resulting in huge variances from the metered value of the bills inserted into the gaming machine. Therefore, it is desired to provide a method and system of accurately and efficiently tracking drop boxes at the gaming machine location.

Gaming machines have an internal reservoir for coins and/or tokens and this reservoir is commonly referred to as a hopper. A gaming machine may or may not have “reserve fills,” which are bags of coins and/or tokens located in the base of the gaming machine used to replenish the supply of coins or tokens in a hopper. If a player wins money from his or her play on a gaming machine (with the exception of a jackpot, which is discussed below), the gaming machine dispenses coins or tokens to the customer that equal the amount of money the player won. If the hopper runs out of coins or tokens, the gaming machine is no longer operational, and is in need of replenishment, commonly known in the art as a machine “fill.” As is well known in the art, lights are located on top of gaming machines and these lights are illuminated in a manner that indicates when the hopper runs out of coins and tokens. These lights are commonly referred to as candles. Casino employees go to the machines that have illuminated candles in order to perform a hopper fill transaction so that the machines can once again become operational. In the gaming industry, there are two commonly used approaches to a fill transaction, one using employee computer terminals placed at strategic locations throughout the casino, and another using a “dispatch” group to handle these machine fills. In the first scenario, employees will leave the machine being serviced and go to a booth where a hardwired employee computer terminal is located for the employee to enter the information regarding the transaction and perform a verification of the fill information for internal security purposes. This transaction requires the employee to leave the player area, and adds a tremendous amount of time and effort to completing the hopper fill transaction. In the second scenario, a dedicated set of hardwired computer terminals are set up off the casino floor, and the personnel operating those terminals are contacted by employees from the casino floor via radio. The personnel manning those computers are often referred to in the gaming industry as “dispatch.” Thereafter, for internal security purposes, the casino employee radios to the dispatch personnel associated with the casino to verify that the gaming machine hopper needs to be filled. The dispatch personnel ensure that the information obtained from the machine itself, as radioed in by the casino employee, corresponds with the metered information associated with a machine stored on the casino's databases. Due to the noise level on the casino floor, the casino employee and the dispatch personnel may have trouble effectively communicating with each other with the radios (the same is true for two casino employees trying to communicate with one another on the floor via radios). Additionally, due to the nature of using radios for communication, only one conversation and transaction can occur at a time. This can create a tremendous waiting period, especially in the face of considerable business levels which can occur on a casino floor during peak periods. Further, it may be necessary to obtain a supervisor's approval prior to completing the fill if the fill is over a pre-determined amount. If the gaming machine has a reserve fill, once the dispatch personnel verify that the hopper needs to be filled, the dispatch personnel enter this information in the casino's computer system and print the information at a printer located in a cage. The casino employee then empties the reserve fill into the machine. Thereafter, the gaming machine is operational. However, the employee must then travel to the cage and pick up a reserve fill to replenish the gaming machine based on the information that the dispatch personnel printed to the printer at the cage. The employee then travels back to the gaming machine with the reserve fill to place inside the gaming machine. If the gaming machine does not have a reserve fill, after the dispatch personnel prints the hopper fill information at the cage, the employee simply goes to the cage to pick up money and coins to fill the hopper.

The prior art systems and methods for filling the hopper when it runs out of coins and tokens have several shortcomings. The fill must be verified by the dispatch personnel or personally by the employee on an employee computer terminal located away from the service area and, additionally, may need a supervisor's approval, which is a time consuming process, especially if the casino is busy. During the fill process, the gaming machine is not operational. Thus, for every minute the gaming machine is not operational, the casino is losing money. In addition, in the prior art systems the employee cannot verify the hopper fill information at the gaming machine because the employee does not have access to the hopper fill information at the gaming machine. Finally, additional casino employees are utilized for every hopper fill if dispatch personnel are involved in the fill process, which is inefficient and expensive. For these reasons, it is desired to provide a method and system that allows the casino employee to verify the hopper fill information at the location of the gaming machine.

Prior art systems and methods for jackpot processing are very similar to hopper fill processing. Thus, similar disadvantages are associated with the prior art methods and systems for both processes. If a player wins a jackpot from his or her play on a gaming machine, the candle located on top of the gaming machine is illuminated in a manner that indicates the player has won a jackpot. The gaming machine is not operational until the jackpot has been processed. In one prior art approach, casino employees go to the machines that have illuminated candles. Thereafter, for internal security purposes, the casino employee must either radio to the dispatch personnel, or must go to a dedicated hardwired employee computer terminal located somewhere in the casino facility, but away from the service area, in order to verify that the player indeed won a jackpot and the amount of the jackpot. Again, the employee may need a supervisor's approval to process the jackpot if the jackpot is over a certain amount of money. Dispatch personnel verify the information given by the employee with the information contained in the casino's computer system from the metering of the gaming machine. If the employee carries a wallet, as such term is used in the casino industry, once the dispatch personnel verify the jackpot information, the dispatch personnel print the information at a printer located in a cage. The casino employee then takes money from his or her wallet and pays the player the jackpot amount. The employee must then travel to the cage and pick up money to replace the money in the employee's wallet based on the information that the dispatch personnel printed to the printer at the cage. If the employee does not carry a wallet or the amount of money in the wallet does not cover the jackpot amount, after the dispatch personnel print the jackpot information at the cage, the employee must go to the cage to pick up the money necessary to pay the winning player the jackpot amount. The casino employee then goes back to the winning gaming machine and pays the jackpot amount to the winning player.

The prior art systems and methods for processing jackpots have several shortcomings. The jackpot information must either be radioed into and verified by dispatch personnel, or verified by the casino employee at a remote hardwired employee computer terminal, both of which are time consuming processes, especially if the casino is busy. The process may be even longer if the employee needs to find an available supervisor to authorize the payment of the jackpot. During the processing of the jackpot, the gaming machine is not operational. Thus, for every minute the gaming machine is not operational, the casino is losing money. Further, players may become very dissatisfied as they wait a considerable length of time after winning a jackpot before they are actually paid their jackpot, diminishing the impact of winning money from the casino. In addition, in the prior art systems, the employee cannot verify the jackpot information at the gaming machine because the employee does not have access to the jackpot information at the gaming machine. Finally, if dispatch personnel are used for verifying jackpot information, additional casino employees are needed for the processing of every jackpot, which is inefficient and expensive. Therefore, it is desired to provide a method and system that allows the casino employee to verify the jackpot information at the location of the winning gaming machine.

Overall, it is desired to provide a wireless casino information management system and method that allows casino employees to input and access extensive player and gaming machine information, as well as perform casino transactions based on that information, at any location on the casino floor in real time in order to provide better service to casino players and to decrease the time and expense associated with inputting and accessing such information and performing casino transactions based on that information.

### SUMMARY

The present invention comprises a system for conducting casino business at any location within a casino, and its method of use. Included in the system are a host server comprising a memory, a database associated with the memory, data relative to the casino business retrievably stored in the memory in accordance with the database, a handheld computing device capable of being transported to any location within the casino, the handheld device comprising a data entry system and a display system, and a wireless communication system operably coupled between the host server and the handheld computing device, the wireless communication system configured for bi-directional communication of the casino business data between the host server and the handheld computing device. In one embodiment, the wireless communication system comprises radio frequency signals.

In another embodiment, the wireless communication system operably coupled between the host server and the handheld computing device is configured to (1) retrieve select casino business data from the host server in response to a request for that select casino business data input via the data entry system of the handheld computing device; (2) communicate casino business data input via the data entry system to the host server so that the input casino business data can be retrievably stored in the memory in accordance with the database; and (3) communicate a command input via the data entry system relative to the casino business data to the host server so that the host server can operate to complete the command.

In operation, a system user establishes wireless communication between the host server and the handheld-computing device so that the casino business data is communicated between the host server and the handheld computing device. For example, a system user inputs a request for select casino business data via the data entry system. The requested casino business data is then retrieved from the host server in response to the request, and is communicated to the handheld computing device. The retrieved casino business data is displayed on the display system. In addition, a system user inputs casino business data via the data entry system, and the input casino business data is communicated to the host server where it is retrievably stored in the memory in accordance with the database. Further, a system user inputs a command via the data entry system relative to the casino business data. The command is communicated to the host server, and the host server completes the command.

These and other advantages of the present invention, and the manner of attaining them, will be more apparent and better understood by reference to the following descriptions of embodiments of the invention taken in conjunction with the accompanying drawings and with the appended claims.

### BRIEF DESCRIPTION OF THE DRAWINGS

FIG. 1 shows a block diagram of one embodiment of the components of the wireless casino information management system according to the present invention;

FIG. 2 shows a second embodiment of the components of the wireless casino information management system of the present invention;

FIG. 3 shows a third embodiment of the components of the wireless casino information management system of the present invention;

FIG. 4 shows an exemplary log-in screen of the present invention;

FIG. 5 shows an exemplary services menu screen of one embodiment of the present invention;

FIG. 6 shows an exemplary slot tracking services option menu screen according to the present invention;

FIG. 7 shows an exemplary drop box processing screen of one embodiment of the present invention;

FIG. 8 shows an exemplary beverage request screen of one embodiment of the present invention;

FIG. 9 shows an exemplary beverage request processed screen of the present invention;

FIG. 10 shows an exemplary handheld users screen of one embodiment of the present invention;

FIG. 11 shows an exemplary message screen of the present invention;

FIG. 12 shows a flow diagram of the method for processing hopper fills according to the present invention;

FIG. 13 shows an exemplary hopper fill screen of the present invention;

FIG. 14 shows an exemplary hopper fill validation screen of one embodiment of the present invention;

FIG. 15 shows an exemplary hopper fill supervisor authorization screen of the present invention;

FIG. 16 shows an exemplary hopper fill printers screen of the present invention;

FIG. 17 shows an exemplary hopper fill verified screen of the present invention;

FIG. 18 shows an exemplary machine lookup screen of the present invention;

FIG. 19 shows an exemplary general machine information screen of one embodiment of the present invention;

FIG. 20 shows an exemplary network information screen of the present invention;

FIG. 21 shows an exemplary meter information screen of one embodiment of the present invention;

FIG. 22 shows an exemplary hot player machine denomination screen of the present invention;

FIG. 23 shows an exemplary hot player information screen of the present invention;

FIG. 24 shows a flow diagram of the method for processing jackpots in accordance with the present invention;

FIG. 25 shows an exemplary jackpot machine number screen of the present invention;

FIG. 26 shows an exemplary jackpot list screen of the present invention;

FIG. 27 shows an exemplary jackpot validation screen of the present invention;

FIG. 28 shows an exemplary jackpot supervisor authorization screen of one embodiment of the present invention;

FIG. 29 shows an exemplary jackpot printers screen of the present invention;

FIG. 30 shows an exemplary jackpot verified screen of the present invention;

FIG. 31 shows an exemplary player lookup screen of the present invention;

FIG. 32 shows an exemplary player tracking services options menu of one embodiment of the present invention;

FIG. 33 shows an exemplary player remarks screen of the present invention;

FIG. 34 shows an exemplary player information screen of the present invention;

FIG. 35 shows an exemplary player address information screen of the present invention;

FIG. 36 shows an exemplary customer loyalty program screen summarizing overall player contributions and point balances according to one embodiment of the present invention;

FIG. 37 shows an exemplary trip history screen of the present invention;

FIG. 38 shows an exemplary table ratings screen according to one embodiment of the present invention;

FIG. 39 shows an exemplary table rating entry screen of the present invention;

FIG. 40 shows an exemplary wager entry screen of the present invention;

FIG. 41 shows an exemplary comp evaluation screen according to one embodiment of the present invention;

FIG. 42 shows an exemplary comp description screen of the present invention;

FIG. 43 shows an exemplary comp information entry screen of the present invention;

FIG. 44 shows an exemplary W-2G information screen according to one embodiment of the present invention;

FIG. 45 shows an exemplary W-2G identification screen according to one embodiment of the present invention; and

FIG. 46 shows an exemplary locate player screen of the present invention.

### DETAILED DESCRIPTION OF THE INVENTION

System Hardware and Operation

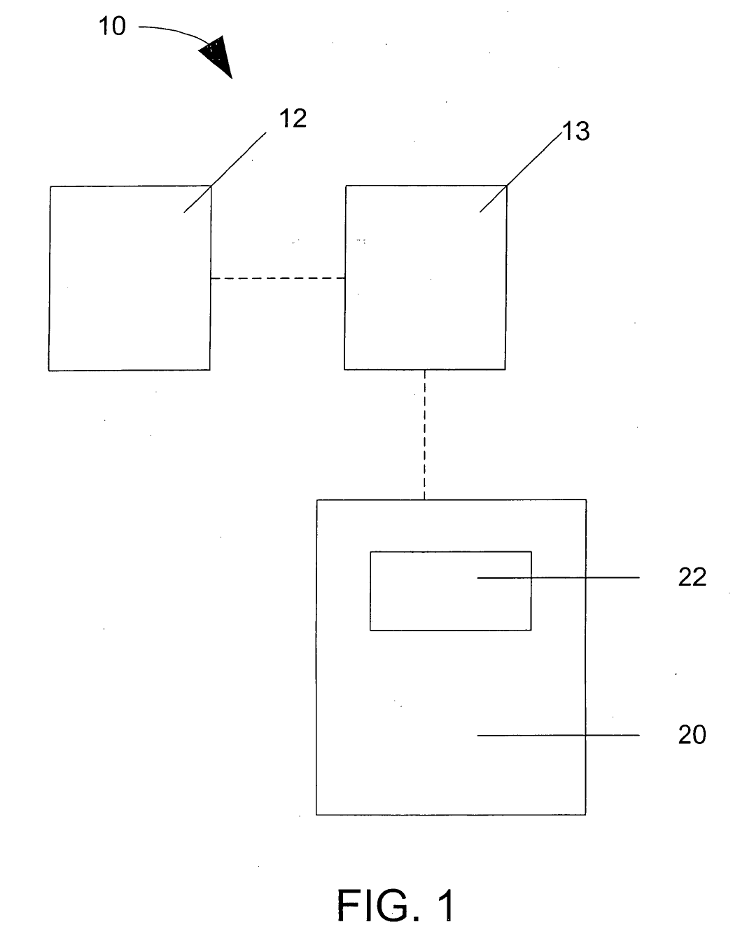

Referring now to FIG. 1, there is shown one embodiment of the components of the wireless casino information management system 10. System 10 comprises handheld device 12, wireless communication system 13, casino server 20 and database 22. Handheld device 12 is a handheld computing device, or system of a type known in the art, such as a handheld computer, wireless mobile telephone, personal digital assistant device, and the like. Handheld device 12 may comprise one of many well known handheld devices including, but not limited to SYMBOL's SPT 1800 Pocket PC, COMPAQ's iPAQ Pocket PC or HP's Jornada Pocket PC. Handheld device 12 comprises such software, hardware, and componentry as would occur to one of skill in the art, such as, for example, one or more microprocessors, memory systems, input/output devices, device controllers, and the like. Handheld device 12 also comprises one or more data entry systems (not shown in FIG. 1) operable by a user of handheld device 12, such as, for example, a pointing device, keyboard, touchscreen, microphone, voice recognition, and/or other data entry systems known in the art. In one embodiment of the present invention, the data entry system has a surface that is sensitive to pressure and may be used to capture signatures. Handheld device 12 may also comprise an audio system (not shown in FIG. 1) for emitting an audible output such as speakers, head phones, or ear phones.

Handheld device 12 further comprises a display system (not shown in FIG. 1) which may comprise many of the well known display devices such as liquid crystal diode displays, light emitting diode displays, etc., upon which information may be displayed in a manner perceptible to the user. Handheld device 12 may also comprise a data receiving system including, but not limited to a bar code reader, digital camera, or an iris or fingerprint recognition system. The configuration of handheld device 12 in a particular implementation of the present invention is left to the discretion of the practitioner.

For purposes of clarity, only one handheld device is shown in FIG. 1. However, it is within the scope of the present invention, and it will be appreciated by those of ordinary skill in the art, that the system of the present invention may have two or more handheld devices operating at the same time.

Handheld device 12 bi-directionally communicates with casino server 20 through wireless communications system 13 of a type well known in the art including, but not limited to systems that utilize ultrasonic signals, infrared signals and radio frequency signals (“RF”). This wireless communication system 13 allows casino personnel to input and access extensive player and gaming machine information and perform casino transactions at any location on the casino floor including, but not limited to the player's location, as described in more detail below. The present invention allows all of these transactions to be performed in real-time with sub-second response times.

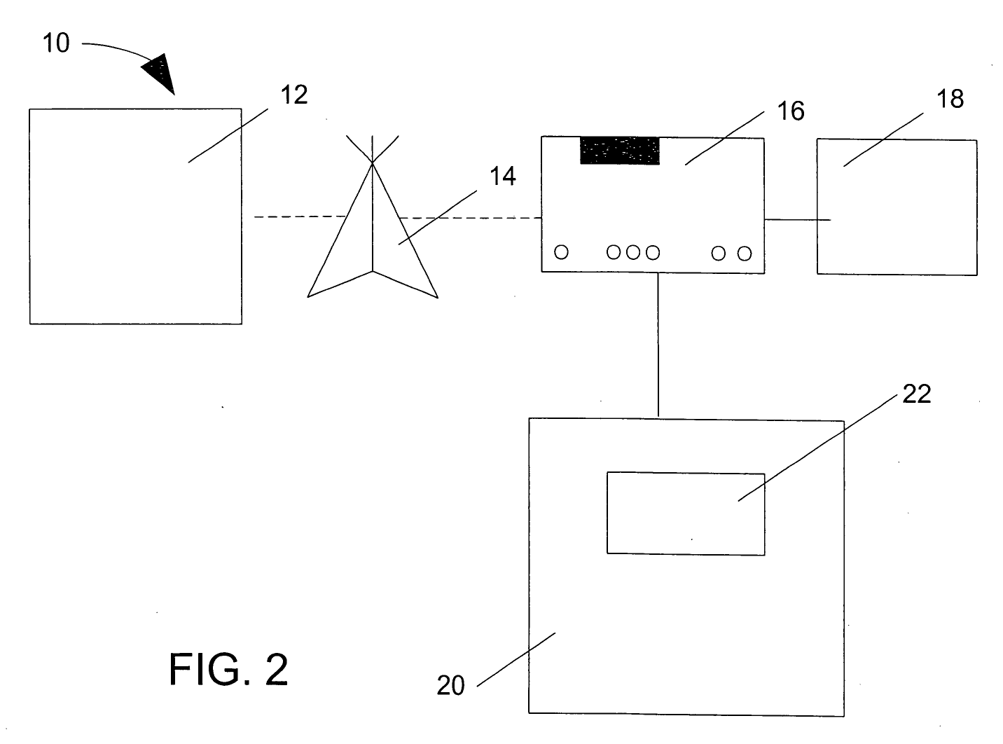

As shown in the embodiment of the present invention illustrated in FIG. 2, wireless communications system 13 (not shown) comprises a RF communications system. In this embodiment, the bi-directional RF communication between handheld device 12 and casino server 20 meets the 802.11b specifications set forth by the Institute of Electrical and Electronics Engineers (“IEEE”). In another embodiment, the RF communication meets the 802.11a specifications set forth by the IEEE. In the embodiment of the present invention shown in FIG. 2, the RF communication from handheld device 12 is received by wireless access point 14. Wireless access point 14 may comprise, for example, an antenna but could, for example, comprise a heat sensor if the system was based on infrared signal transmission. Wireless access point 14 is capable of both receiving information from handheld device 12, as well as transmitting information to handheld device 12. Wireless access point 14 may comprise a plurality of wireless access points positioned at different locations throughout the casino. A plurality of wireless access points 14 provide a blanket of radio or signal coverage throughout the casino facility, allowing transactions to be performed in a uniform fashion throughout the casino facility. In turn, through systems well known in the prior art, wireless access point 14 bi-directionally communicates with hub 16. Hub 16 may comprise a plurality of hubs positioned at different locations throughout the casino to support a plurality of wireless access points 14. Wireless access points 14 are attached to ports (not shown in FIG. 2) on hub 16 via a hardwire as is well known in the art.

In the embodiment of the present invention illustrated in FIG. 2, system 10 further comprises an application server 18. Hub 16 is capable of bi-directional communication with application server 18 through communication systems well known in the art. In turn, application server 18 is capable of bi-directional communication with casino server 20 through hub 16. Application server 18 comprises one or more server computers, computing devices, or systems of a type known in the art. Application server 18 is programmed and configured with such software, hardware, and componentry as would occur to one of skill in the art, such as, for example, memory systems, microprocessors, input/output devices, device controllers, video display systems, and the like. In addition, application server 18 is programmed and configured with such software, hardware, and componentry necessary to perform the following functions: (1) application server 18 manages the security system that prevents unauthorized users of handheld device 12 from communicating with casino server 20; (2) application server 18 manages the access to casino server 20 for the performance of certain casino transactions (described in more detail below) to those users authorized to perform such casino transactions; (3) application server 18 connects handheld device 12 with casino server 20; (4) application server 18 communicates commands from handheld device 12 to casino server 20; and (5) application server 18 communicates casino server 20's answers to handheld device 12, all via hub 16. In one embodiment of the present invention, application server 18 comprises a MICROSOFT WINDOWS NT Server.

It will be recognized by one of ordinary skill in the art that application servers, such as application server 18, may provide certain functions including, but not limited to those listed above. However, application server 18 is not necessary to the operation of the present invention. In one embodiment of the present invention, handheld device 12 may bi-directionally communicate with casino server 20 directly, without the use of an application server, such as application server 18. The operation of the present invention simply requires that handheld device 12 be able to bi-directionally communicate with casino server 20 through a wireless communications system as shown in FIG. 1.

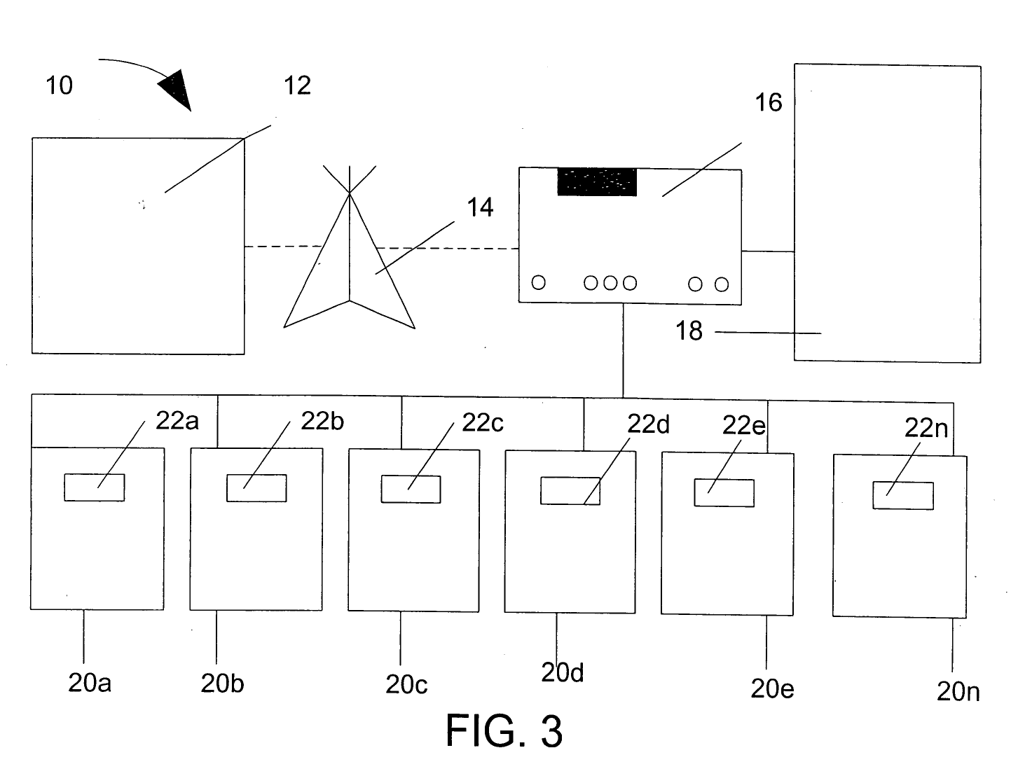

Casino server 20 comprises one or more server computers, computing devices, or systems of a type known in the art, collectively known as casino systems. Casino server 20 further comprises such software, hardware, and componentry as would occur to one of skill in the art, such as, for example, microprocessors, memory systems, input/output devices, device controllers, display systems, and the like. Casino server 20 may comprise one of many well known servers, such as, for example, IBM's AS/400 Server, IBM's AIX UNIX Server, or MICROSOFT's WINDOWS NT Server. In FIG. 1 and FIG. 2, casino server 20 is shown and referred to herein as a single server. However, casino server 20 need not be a single server. As discussed below with respect to FIG. 3, casino server 20 may comprise a plurality of servers or other computing devices or systems interconnected by hardware and software systems known in the art which collectively are operable to perform the functions allocated to casino server 20 in accordance with the present invention.

Database 22 is associated with casino server 20. More specifically, database 22 is associated with the memory of casino server 20. According to the present invention, database 22 is associated with casino server 20 where, as shown in the embodiments in FIG. 1 and FIG. 2, database 22 resides on casino server 20. Database 22 is also associated with casino server 20 where database 22 resides on a server or computing device remote from casino server 20, provided that the remote server or computing device is capable of bi-directional data transfer with casino server 20. Preferably, the remote server or computing device upon which database 22 resides is electronically connected to casino server 20 such that the remote server or computing device is capable of continuous bi-directional data transfer with casino server 20.

For purposes of clarity, database 22 is shown in FIG. 1 and FIG. 2, and referred to herein as a single database. It will be appreciated by those of ordinary skill in the art that database 22 may comprise a plurality of databases connected by software systems of a type well known in the art, which collectively are operable to perform the functions delegated to database 22 according to the present invention. Database 22 may comprise a relational database architecture or other database architecture of a type known in the database art. Database 22 may comprise one of many well known database management systems, such as, for example, MICROSOFT's SQL Server, MICROSOFT's ACCESS, or IBM's DB2 database management systems, or the database management systems available from ORACLE or SYBASE. Database 22 retrievably stores extensive information regarding the casino's operations including, but not limited to general player and gaming machine information, information related to a player's gambling activities including, such as, for example, the player's table ratings and theoretical win profile. This information retrievably stored on database 22 is communicated to database 22 from a variety of remote devices (not shown in FIG. 1 or FIG. 2) through systems well known in the art. One such remote device is handheld device 12, which is discussed herein. However, other remote devices include, but are not limited to the hardwired employee computer terminals, point of sale terminals, and the data collection devices that poll the meters associated with the gaming machines.

FIG. 3 shows an alternative embodiment of system 10 wherein casino server 20 comprises a plurality of casino servers, namely, casino servers 20a-n for the monitoring, tracking and processing of information that is generated by different areas of a casino's operations. In the embodiment shown in FIG. 3, casino server 20a comprises a casino management system (“CMS”) for monitoring, tracking, and processing extensive information about players and is commonly understood in the casino industry. For example, the CMS comprises the software, hardware, and componentry necessary to monitor, track, and generate a player's comp evaluation profile. In another example, when a player uses his or her player's card when participating in gaming activities at a casino, the CMS monitors and generates the trip history of a player. A “trip” is any number of days of play followed by a period of no gaming activity. A trip history may include information about the player's total win or loss, and the casino's total theoretical win with respect to the player (the term “theoretical win” refers to the casino's estimated winnings from a customer from certain types of gaming activities). Database 22a is associated with casino server 20a for retrievably storing the data associated with casino server 20a. Database 22a may comprise a plurality of databases.

Casino server 20b comprises a hotel management system (“HMS”) for monitoring, tracking and processing information related to a casino's hotel activities. Many casinos have associated hotels to accommodate players that wish to spend the night at the casino. An HMS is well known in the art. The HMS comprises the software, hardware, and componentry necessary for managing the hotel operations of a casino including, but not limited to room reservations. Database 22b is associated with casino server 20b for retrievably storing the data associated with casino server 20b. Database 22b may comprise a plurality of databases.

Casino server 20c comprises a retail point of sale, food and beverage, and entertainment system (referred to herein as an entertainment management system or “EMS”). The EMS comprises the software, hardware, and componentry necessary for monitoring, tracking, and processing information related to various retail, food and beverage, and entertainment activities and is well known in the art. For example, the EMS may handle entertainment activities, such as tickets for concerts, shows, and events associated with the casino. Database 22c is associated with casino server 20b for retrievably storing the data associated with casino server 20c and may comprise a plurality of databases.

Casino server 20d comprises a slot management and accounting system (“SMS”). The SMS comprises the software, hardware, and componentry necessary to monitor, track, and process various information related to the slot machines at the casino, as well as various related accounting activities and information, and patrons' play as it relates to the CMS, and is well known in the art. For example, casino server 20d monitors and tracks information related to slot machines, such as coin in and coin out information and the theoretical hold associated with a particular slot machine. Database 22d is associated with casino server 20d for retrievably storing the data associated with casino server 20d and may comprise a plurality of databases.

Finally, casino server 20e comprises an automated valet management system (“VMS”). The VMS comprises the software, hardware, and componentry necessary for monitoring, tracking, and processing information related to the valet parking at a casino and is well known in the art. For example, the VMS may track the location of a player's parked car while the player is gambling at the casino. Database 22e is associated with casino server 20e for retrievably storing the data associated with casino server 20e. Database 22e may comprise a plurality of databases.

Casino server 20n simply represents the infinite possibility for servers or computing devices to monitor, track, and process information related to the various activities performed at a casino. At least one database 22n is associated with casino server 20n.

During operation of the present invention, communication between handheld device 12 and casino server 20 is achieved by systems known in the art for communicating with and through a network, such as system 10. For example, the communication may be in accordance with the transmission control protocol/Internet protocol (“TCP/IP”), the hypertext transfer protocol (“HTTP”), the file transfer protocol (“FTP”), the wireless access protocol (“WAP”), and/or other communication protocols known in the art. In the embodiments of the present invention shown in FIGS. 1, 2 and 3, the communication between handheld device 12 and casino server 20 is in accordance with TCP/IP. In the embodiments shown in FIGS. 2 and 3, the only communication requirement for application server 18 is that it is able to bi-directionally communicate with any TCP/IP compliant host, such as casino server 20.

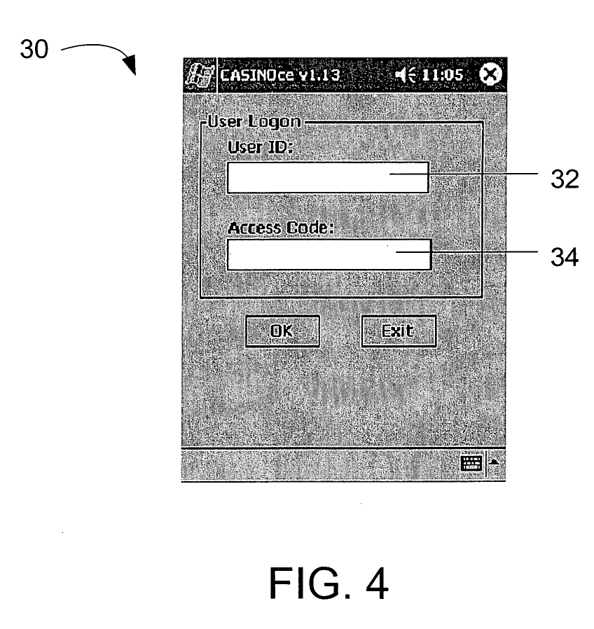

To operate system 10 according to the present invention, a user of handheld device 12 powers up handheld device 12. After the user powers up handheld device 12, the user establishes bi-directional communication between handheld device 12 and casino server 20. In one embodiment of the present invention, the user establishes bi-directional communication between handheld device 12 and casino server 20 through a log-in process. An exemplary log-in screen 30 is shown in FIG. 4. In this embodiment of the present invention, using the data entry system of handheld device 12, the user enters a user identification number 32 and an access code 34 assigned by the casino in order to successfully log-in. If the user enters a valid user identification number and access code, system 10 verifies both and permits access by the user. Once the user successfully enters the user identification number 32 and access code 34, and bi-directional communication is established between handheld device 12 and casino server 20 through wireless communication system 13, system 10 is ready for use. In another embodiment, the user may log-in using any one of the commercially available fingerprint recognition systems.

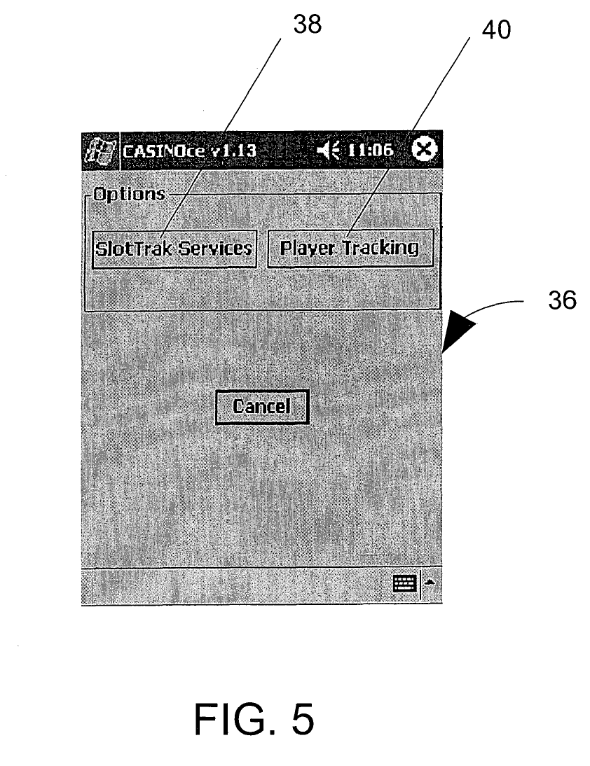

After successfully entering the user identification number 32 and access code 34, the user is presented with a menu containing a plurality of types of casino services that the user may access using handheld device 12. FIG. 5 shows an exemplary services menu screen 36 on which two casino services options are presented to the user; namely, a slot tracking services option 38 and a player tracking services option 40. It will be appreciated by those of skill in the art that other types of casino services options may be presented to the user including, but not limited to a valet tracking service option or a food and beverage tracking service option.

Before discussing slot tracking services option 38 and player tracking services option 40, a general overview of the operation of system 10 is provided. A user of handheld device 12 uses the data entry system to enter a command, request information, or to input information. In one embodiment, these selections are communicated to wireless access point 14 via RF. As is well known in the art, wireless access point 14 communicates the selection to hub 16. In turn, as is well known in the art, hub 16 communicates with application server 18. Application server 18, among other functions, manages the security to casino server 20, including managing the access of users to casino server 20 and their particular rights to conduct certain transactions thereafter, and communicates the selections from handheld device 12 to casino server 20 through hub 16. Thereafter, if handheld device 12 was used to input information, this information is stored on database 22. If handheld device 12 was used to enter a command or request information, casino server 20 performs the command or retrieves the information from database 22 and this information or completed task is communicated back to handheld device 12 through the wireless communications system 13 described above and displayed on the display system.

Slot Tracking Services

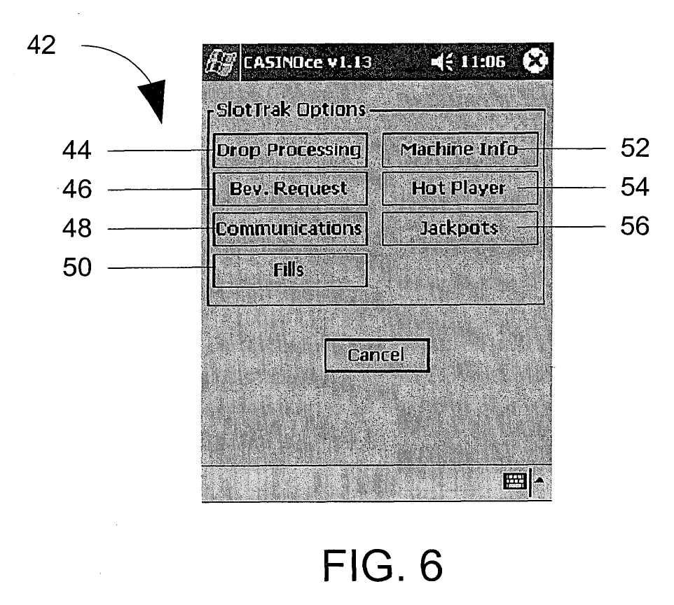

If the user selects slot tracking services option 38, a slot tracking service options menu is displayed on the display system of handheld device 12. FIG. 6 shows an exemplary slot tracking services options menu 42. In this embodiment, seven slot tracking service options are presented to the user, namely, drop box processing option 44, beverage request option 46, communications option 48, fill processing option 50, machine information option 52, hot player location option 54, and jackpot processing option 56. It will be appreciated by those of skill in the art that additional slot tracking services options may be presented to the user. The user selects which slot tracking service the user desires to access using the data entry system of handheld device 12.

1. Drop Box Processing.

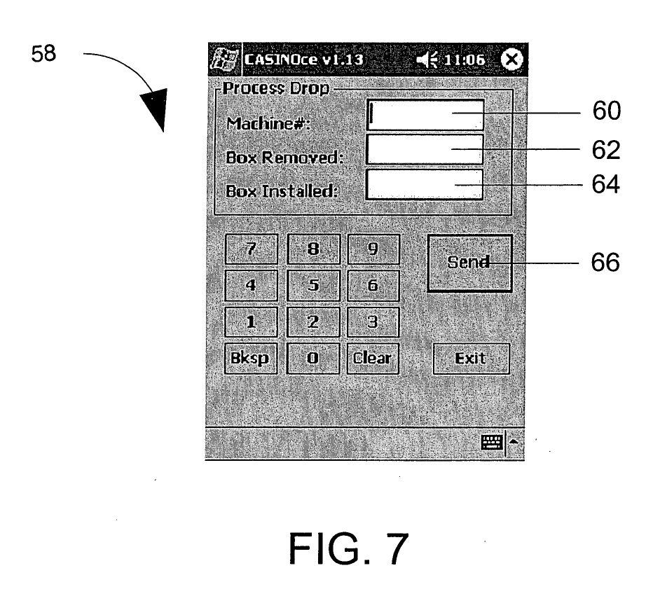

As is commonly known in the art, a user must rotate the drop boxes. This rotation is done to remove the box containing the money from the machine, and replace it with a box containing no money. Tracking of these boxes is the commonly known key to preventing theft of money by those with access to these boxes. To accomplish this, the user selects drop box processing option 44 and the user is then shown a drop box processing screen on the display system. FIG. 7 shows an exemplary drop box processing screen 58. In one embodiment of the present invention, the drop boxes are bar coded. At the drop box processing screen 58, the user enters the number of the gaming machine at which the user desires to rotate the drop boxes in machine number section 60. Thereafter, the user simply scans the bar code associated with the drop box being removed from the gaming machine and the empty drop box being installed in the gaming machine with the bar code reader associated with handheld device 12. Once the bar code reader reads these bar codes, the numbers represented by the bar codes immediately appear at box removed section 62, and box installed section 64 of drop box processing screen 58. In another embodiment, instead of bar codes, the drop boxes are labeled in a manner that can be identified by the user. The user then manually enters these labels in box removed section 62 and box installed section 64 with the data entry system of handheld device 12.

After the user completes machine number section 60, box removed section 62 and box installed section 64 of drop box processing screen 58, using the data entry system, the user selects send option 66. Thereafter, the drop box processing information is communicated from handheld device 12 to casino server 20 and stored on database 22.

The processing of drop boxes according to the present invention provides many advantages. First, any drop box can be installed in any gaming machine instead of rotating the same two boxes at a gaming machine. Therefore, casino employees do not know which drop boxes came from the more expensive machines, thereby decreasing the risk of theft of the drop boxes containing the most money. Drop box processing according to the present invention is also more accurate and efficient than prior art systems. The bar codes or labeling allow the casino to more accurately track which drop boxes come from which gaming machines directly at the gaming machine without the time consuming and inaccurate process of monitoring the drop box rotation remotely via surveillance tapes.

2. Beverage Requests.

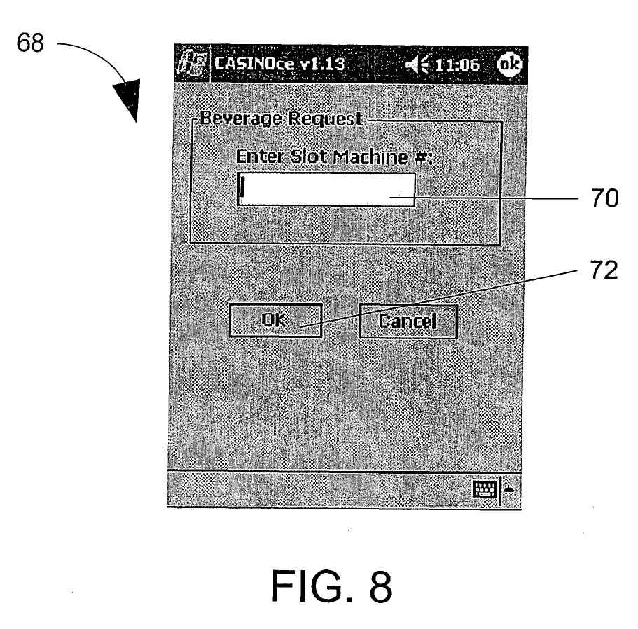

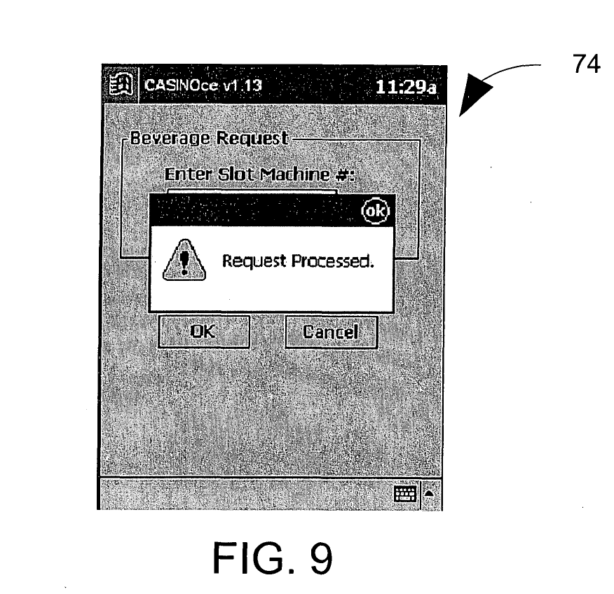

Returning to FIG. 6, if a player desires a drink while participating in gambling activities, using the data entry system, the user selects beverage request option 46 on slot tracking services menu screen 42. If the user selects beverage request option 46, the user is shown a beverage request screen. FIG. 8 shows an exemplary beverage request screen 68. Instead of the user finding a beverage server, or worse, the player leaving his or her gaming location to find a beverage server, from any location on the casino floor the user simply enters the number of the gaming machine where the player desiring a beverage is located at machine number section 70. It will be appreciated by one of ordinary skill in the art that the user could also enter other identifiable locations at which a player is located in addition to a gaming machine location. The user then selects OK option 72. Thereafter, the request for a beverage server at a specific gaming machine or other casino location is communicated to casino server 20. Through systems well known in the art, casino server 20 communicates this beverage request to a remote point of sale terminal and the request is displayed on the display system associated therewith so that a beverage server can be dispatched to the machine to take the beverage order. In an alternative embodiment, casino server 20 communicates the beverage request to other peripheral communication devices, such as a handheld device, digital pager, cellular telephone, or any other device which can display messaging from an electrically transmitted signal. After the beverage request has been sent to the point of sale terminal for processing by the beverage server, the user is notified that the request is being processed on a beverage request processed screen. An exemplary beverage request processed screen 74 is shown in FIG. 9. As the casino employee, not the player, notifies the beverage server of the player's desire for a beverage, the player can continue his or her gambling activities uninterrupted.

In another embodiment of beverage request option 46, instead of having a beverage server come to the gaming machine or other casino location to take the player's beverage request, the user can actually place the beverage order for a player while at the player's location. In this embodiment, beverage request screen 68 also includes a beverage menu (not shown). The user asks the player which beverage the player desires from the beverage menu. After the user enters the player's location and the beverage preference of the player at that location, the user selects OK option 72. Thereafter, the beverage preference of the player is communicated to a remote point of sale terminal or other peripheral communication device and displayed on the display system associated therewith. In this embodiment, the amount of time for providing a player with a beverage is substantially decreased.

In an alternative embodiment, if a player is a carded player, the player's drink requests may be stored on database 22. After the user selects beverage request option 46, the user enters the location of the carded player desiring a beverage on beverage request screen 68. Thereafter, the user selects OK option 72 to communicate the location of the player desiring a beverage to casino server 20. Assuming the player's card is inserted into the card reader at the player's location, the player's beverage preferences are retrieved from database 22 and communicated from casino server 20 to a remote point of sale terminal or other peripheral communication device and displayed on the display system associated therewith for processing by the beverage servers. In this embodiment, a player can simply state that he or she desires a beverage, and the user can use handheld device 12 to order the player's preferred beverage without even asking the player what the preferred beverage is and interrupting the player's activities at the casino.

3. Communications.

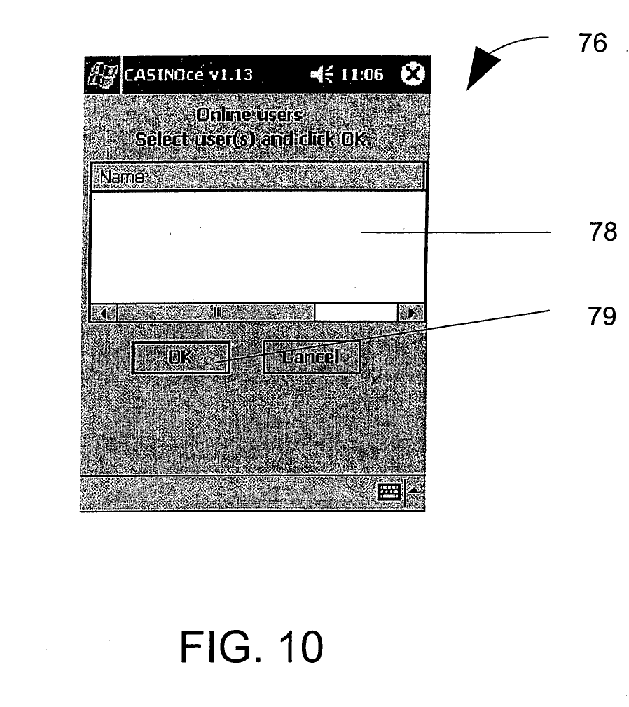

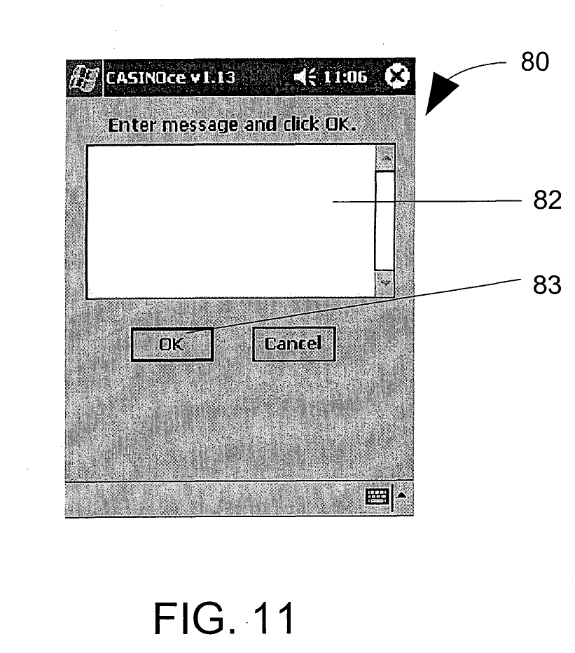

Returning to FIG. 6, if a player desires to communicate with another handheld user, the user selects communications option 48 with the data entry system and this selection is communicated to application server 18. Thereafter, application server 18 communicates a list of all the handheld users currently logged-in to handheld device 12 which is displayed on a handheld users screen on the display system. An exemplary handheld users screen 76 is shown in FIG. 10. It will be appreciated by one of skill in the art that in another embodiment of the present invention, casino server 20 may be utilized instead of application server 18 to provide the list of handheld users currently logged-in. Using the data entry system, the user the selects the handheld user with whom he or she wishes to communicate at handheld users section 78. After the user selects a handheld user with whom to communicate, the user selects OK option 79 and is then shown a message screen. An exemplary message screen 80 is shown in FIG. 11. The user then enters a message in message section 82 using the data entry system. Thereafter, the user selects OK option 83 and the message is communicated to the selected handheld user and is immediately displayed on the display system of the handheld device 12 being utilized by the second handheld user. The selected handheld user can respond to the received message as outlined above. Thus, communications option 48 allows users to communicate with each other at any location on the casino floor without having to find one another on the casino floor, which is very difficult, and without using the often ineffective radios.

4. Fill Processing.

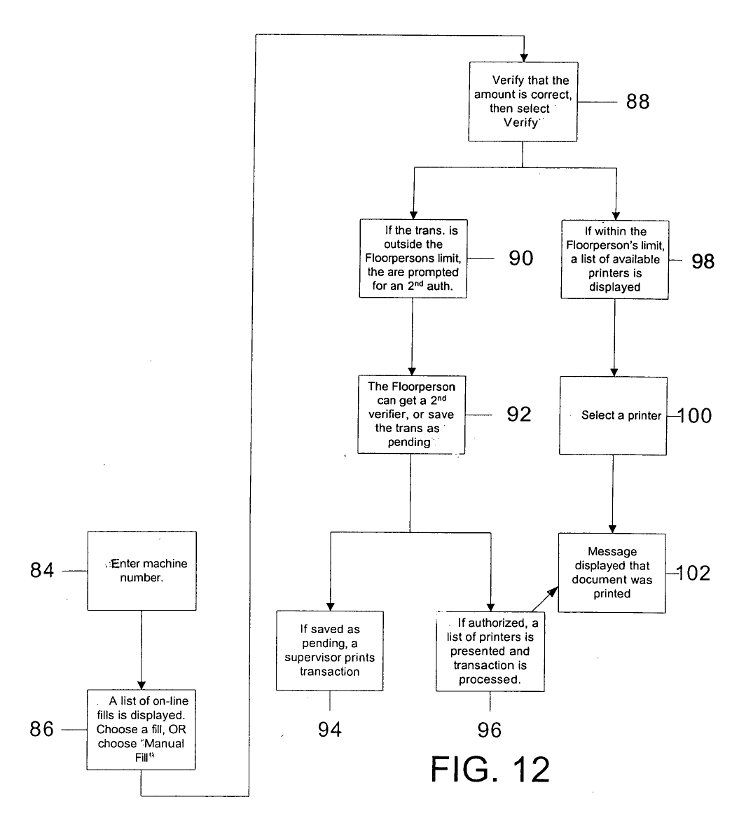

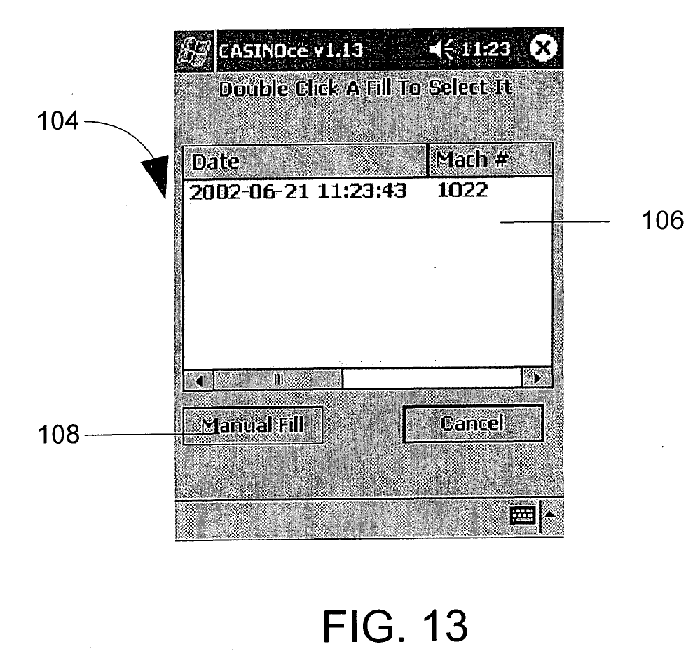

Returning again to FIG. 6, if a user desires to perform a hopper fill, the user selects fill processing option 50. FIG. 12 shows a flow diagram of the method for processing hopper fills according to the present invention. After the user selects fill processing option 50, at step 84, the user enters the number of the gaming machine on which the user desires to perform a fill via the data entry system of handheld device 12. Thereafter, at step 86, the user is shown a fill screen on the display system of handheld device 12. An exemplary hopper fill screen 104 is shown in FIG. 13. At step 86, if the hopper of the selected gaming machine is empty, this gaming machine will be displayed on gaming machine section 106 of fill screen 104. Only one machine number should appear in gaming machine section 106. However, if the hopper is not yet empty, at step 86, the user selects manual fill option 108 if the user wishes to perform a preemptive fill on a machine whose hopper is not yet empty. If the user selects manual fill option 108, the user manually enters the number of the machine on which the user desires to perform a preemptive fill. Casino employees perform preemptive fills in order to minimize the amount of time a gaming machine is out of service by filling nearly empty hoppers while the machine is not being utilized by players.

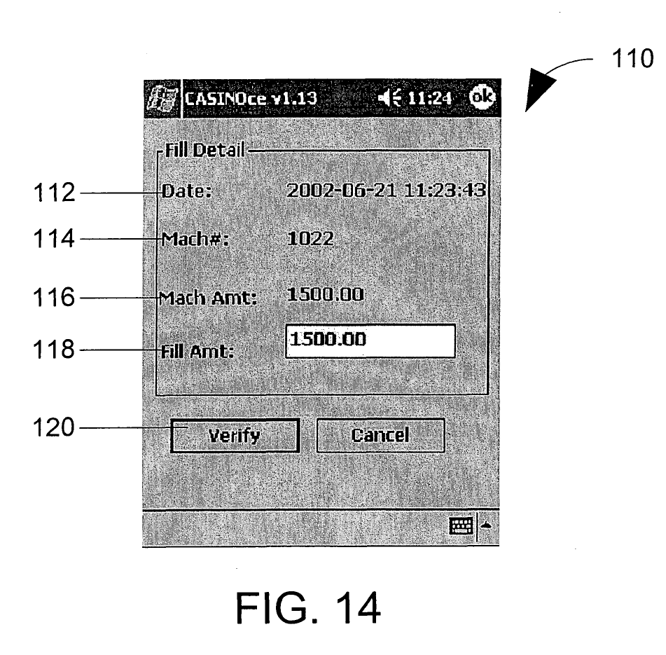

After the user selects the machine listed on gaming machine section 106 or, for preemptive fills, manually enters the machine number, the machine number is communicated to casino server 20. Thereafter, the hopper fill information about a selected gaming machine is retrieved from database 22 and communicated to handheld device 12. The hopper fill information is shown to the user on a hopper fill validation screen on the display system. An exemplary hopper fill validation screen 110 is shown in FIG. 14. The hopper fill information shown on hopper fill validation screen 110 includes, but is not limited to the date of the fill 112, the machine number 114, and the dollar amount that should be used to fill the hopper for that particular machine 116. At step 88, in order to verify the hopper fill information, the user enters the actual amount of the hopper fill in fill amount section 118 and then selects verify option 120. Thereafter, the verified hopper fill information is communicated to casino server 20 and stored on database 22.

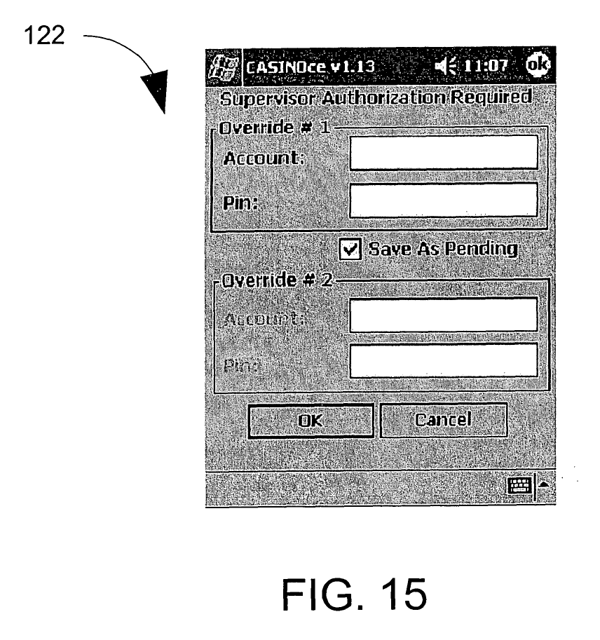

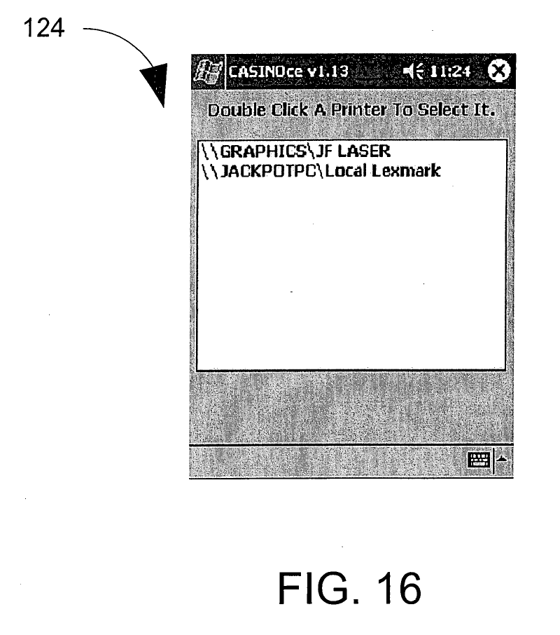

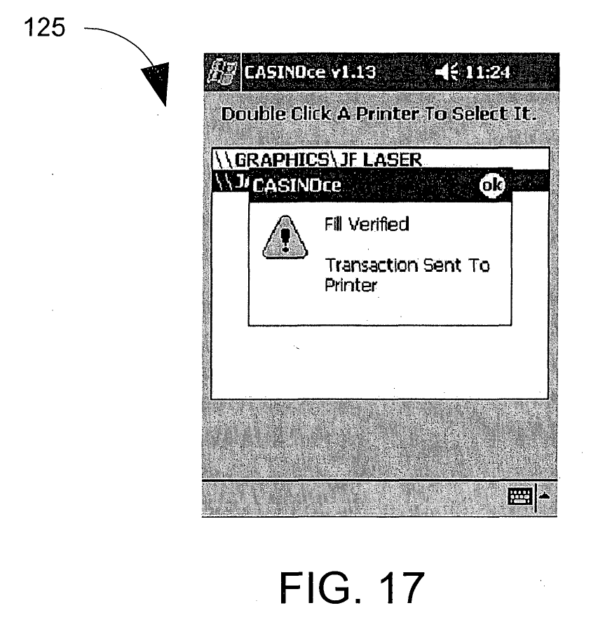

The casino may place a limit on the amount of the hopper fill that employees can perform. If the hopper fill amount exceeds this limit, at step 90 casino server 20 will communicate this information to the user on the display system by prompting the user for the approval of a supervisor on a supervisor authorization screen displayed on the display system. FIG. 15 shows an exemplary hopper fill supervisor authorization screen, 122. Thereafter, at step 92, the user can either get a supervisor to authorize the hopper fill, or, if a supervisor is not readily available, the user can save the transactions as pending. If the supervisor authorizes the transaction, the authorization is communicated to casino server 20 and stored on database 22. Thereafter, at step 96, a list of printers at each of the cages at which the hopper fill information may printed is displayed on a printers screen. Cages are also commonly referred to as booths. An exemplary hopper fill printers screen 124 is shown in FIG. 16. The user selects the printer where he or she desires to print the hopper fill information (in most cases, the printer in the cage closest to the machine on which the user is performing a hopper fill). After the user selects a printer, at step 102 the user is notified that the hopper fill has been verified and that the hopper fill information has been sent to the selected printer on a hopper fill verified screen. An exemplary hopper fill verified screen 125 is shown in FIG. 17. The cage personnel review the verified hopper fill information before giving the user any money. After the hopper fill information is printed at a cage, the user either performs the hopper fill if the gaming machine contains a reserve fill or, if the gaming machine does not contain a reserve fill, the user goes to the cage at which the hopper fill information was printed in order to receive the coins and/or tokens necessary to fill the hopper of the selected machine. If a reserve fill was present, the user goes to the cage for a reserve fill to replace the reserve fill he or she already emptied into the hopper.

If, however, a supervisor is not readily available, the user saves the hopper fill transaction as pending on supervisor authorization screen 122. The supervisor can authorize the hopper fill transaction on his or her own handheld device 12 on supervisor authorization screen 122. After the supervisor authorizes the transaction, the authorization is communicated to casino server 20 and stored on database 22. Thereafter, at step 96, the supervisor is shown the printers screen 124 and selects the printer at which to print the hopper fill information. The supervisor is then shown hopper fill verified screen 125. The supervisor can communicate the printer location to the user by using communications option 48 described above, or by personal or radio communication on the casino floor. The user then performs the hopper fill as described above.

If the hopper fill amount was within the user's authorized limit, at step 98, the user is shown printers screen 124 on the display system. At step 100, the user then selects the printer at which he or she desires to print the hopper fill information. Thereafter, at step 102, the user is shown hopper fill verified screen 125 and the user performs the fill as described above.

Processing hopper fills in accordance with the present invention offers numerous advantages over the prior art. Handheld device 12 allows the user to verify the hopper fill information at the gaming machine itself instead of having to use a remote employee computer terminal or radio the dispatch personnel to verify the hopper fill information. This greatly reduces the time necessary to perform a hopper fill. Therefore, the machine is operational for a longer period of time, leading to greater profits for the casino. Further, if supervisor approval is necessary, the user can save the transactions as pending if a supervisor is not available. Thus, the employees can continue other activities instead of waiting for the supervisor's approval. Finally, as the present invention eliminates the need for dispatch personnel, the casino realizes a decrease in payroll expenses.

5. Machine Information.

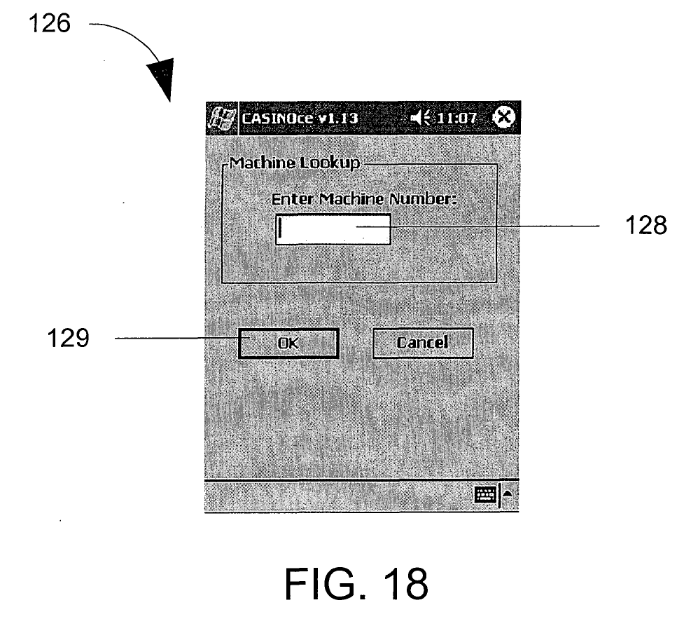

Returning to FIG. 6, if a user desires to view information about a particular gaming machine, the user selects machine information option 52 via the data entry system of handheld device 12. After the user selects machine information option 52, the user is shown a machine lookup screen on the display system of handheld device 12. An exemplary machine lookup screen 126 is shown in FIG. 18. The user then enters the number of the machine about which the user desires information in machine number section 128 and then selects OK option 129. This request for information is then communicated to casino server 20 and the requested information is retrieved from database 22. The retrieved gaming machine information is communicated back to handheld device 12 and displayed on the display system.

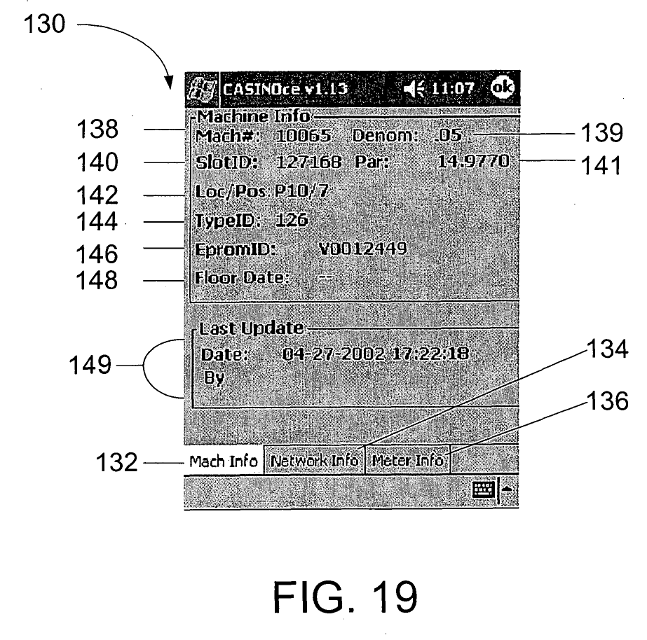

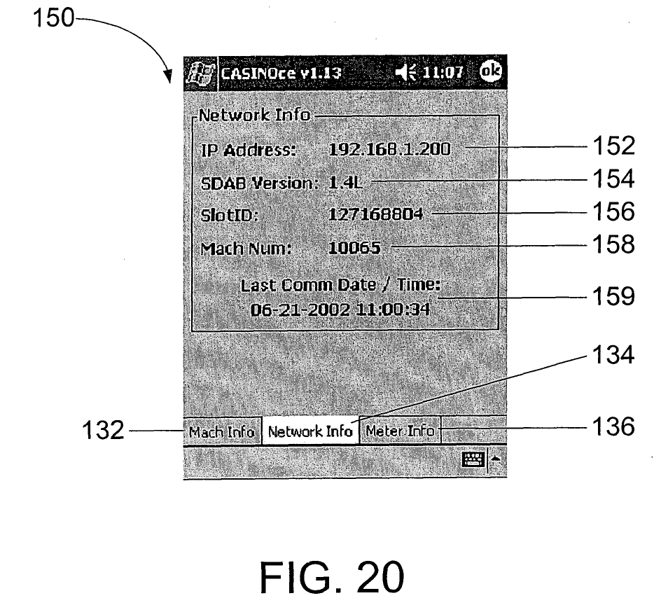

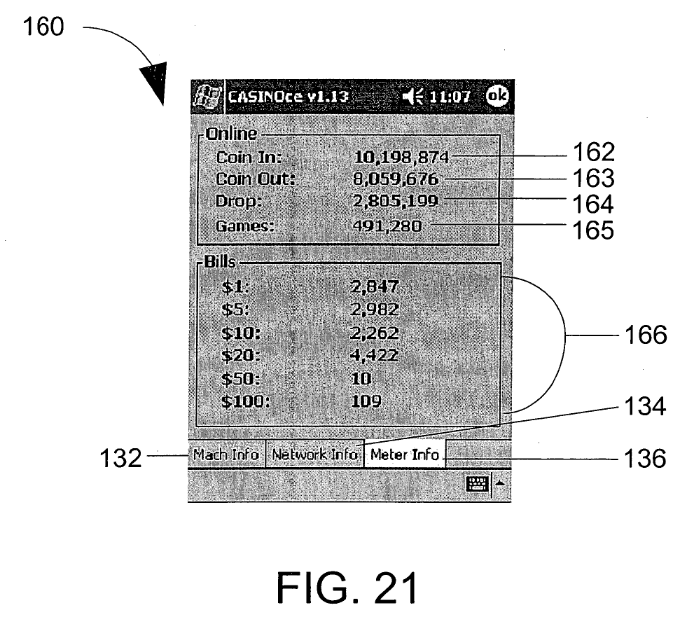

In one embodiment, the user can view three types of gaming machine information, namely, general machine information, network information, and meter information. However, it will be appreciated by one of ordinary skill in the art that any machine information stored on database 22 may be retrieved and communicated to handheld device 20. These three types of gaming information are located on three different screens, namely a general machine information screen, a network information screen, and meter information. However, it will be appreciated by one of ordinary skill in the art that the gaming machine information could also be arranged so that the player information is displayed on one screen or any of a plurality of screens. An exemplary general machine information screen 130 is shown in FIG. 19. An exemplary network information screen 150 is shown in FIG. 20. An exemplary meter information screen 160 is shown in FIG. 21. The user selects which screen to view by selecting machine information tab 132, network information tab 134, or meter information tab 136, respectively.

General machine information screen 130 contains general information about the gaming machine including, but not limited to machine number 138, denomination of the machine 139, slot board identification number 140, theoretical hold of the machine 141, the location and position of the machine 142, identification of the type of gaming machine 144, EPROM identification of the computer chip installed in the gaming machine 146, floor date 148, and the date the general information was last updated or polled for information by the system 149. In another embodiment, the general machine information may also comprise electronic fund transfer (“EFT”) information. The EFT information may include, for example, credits added or removed from the machine, and detailed EFT transactions performed by players at the machine, such as the amount of money involved in the EFT transaction and in which direction the money was moved.

Network information screen 150 contains the network information relevant to the selected gaming machine. The network information includes, but is not limited to IP address 152, software flash code version 154, slot board identification number 156, machine number 158, and the date and time of the last communication between casino server 20 and the machine 159.

Meter information screen 160 sets forth the most recent meter information about a machine. This meter information includes, but is not limited to coin in information 162, coin out information 163, drop box value information 164, number of games played 165, and bill information 166, which is arranged by bill denomination.

Having extensive information about gaming machines available to users at any location on the casino floor has many advantages over casino employees having to access the information at the employee computer terminals. First, it is much more efficient for the employee to access the gaming machine information anywhere on the casino floor. For example, if an employee wanted to check the meter information about a particular machine to determine if a preemptive fill is appropriate, the employee can access the meter information while located at that particular machine instead of having to navigate through the crowded casino floor to find an available employee computer terminal. Further, the elimination of the employee computer terminals allows the casino floor space that was occupied by the employee computer terminals to be used for additional gaming machines or gaming tables.

6. Hot Player.

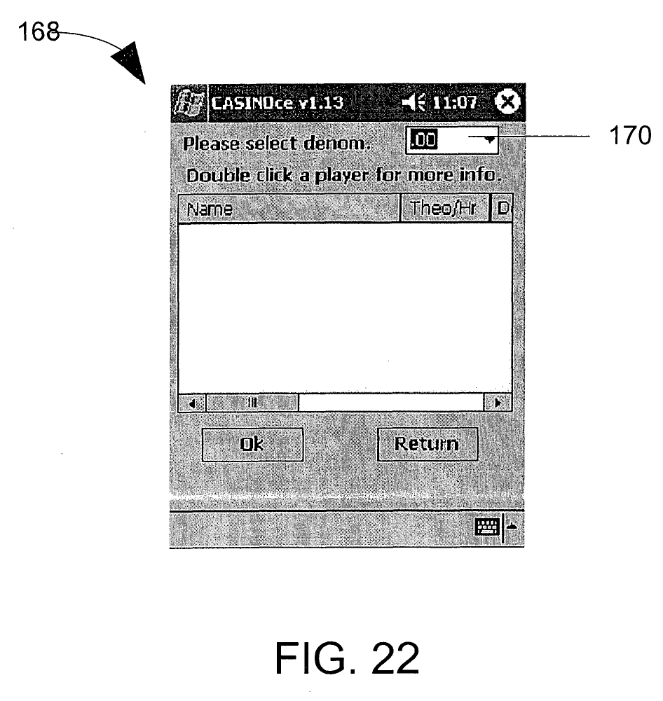

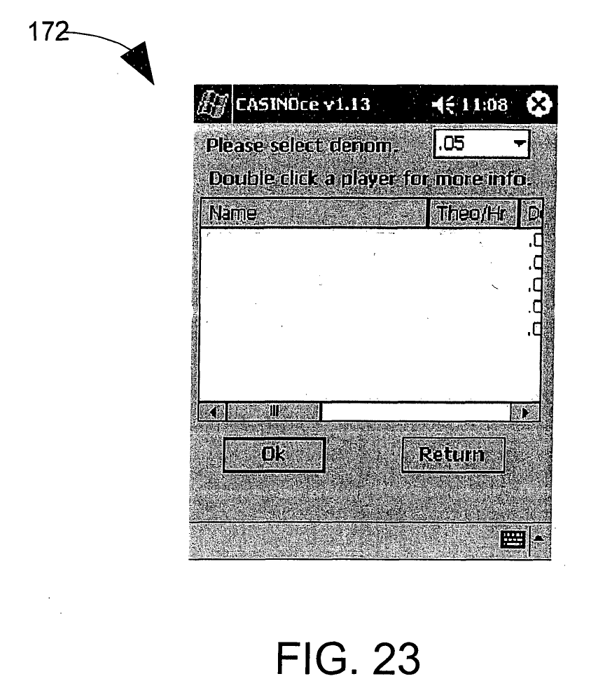

Returning to FIG. 6, if a user desires to locate hot players on the casino floor, the user selects hot player option 54 with the data entry system associated with handheld device 12. The term “hot player” is commonly used in the casino industry to refer to a player who has inserted a sufficiently high amount of money into a gaming machine within a certain time period. Hot players can be both carded or uncarded. After the user selects hot player option 54, the user is shown a hot player machine denomination screen on the display system. An exemplary hot player machine denomination screen 168 is shown in FIG. 22. In denomination section 170, using the data entry system, the user enters the denomination of the gaming machines about which the user desires to view the hot player information. Thereafter, the user's request is communicated to casino server 20 and the relevant information is retrieved from database 22 and communicated back to and displayed on handheld device 12 on a hot player information screen. An exemplary hot player information screen 172 is shown in FIG. 23. Each hot player currently playing at gaming machines of the selected denomination is shown on hot player information screen 172. Using the data entry system, the user can select a particular hot player to view additional information about the hot player. This additional information includes, but is not limited to the theoretical win profile of the player and all relevant play statistics on the session that qualified the player as a hot player including, but not limited to averages per hour, coins played, games played, total revenue, session time, denomination, and dollars played.

Having hot player information available to casino employees at any location on the casino floor is valuable to the casino. For example, if a casino employee locates a hot player that is an uncarded player, the user can approach the hot player and offer to enroll the hot player in the casino's customer loyalty program in order to gain valuable information about the player. If the employee had to leave the hot player to go to an employee computer terminal, the hot player may leave the gaming machine or casino, and the employee will miss an opportunity to enroll the hot player in the casino's customer loyalty program. In addition, using handheld device 12 instead of employee computer terminals allows the employee additional time to interact with players.

7. Jackpot Processing.

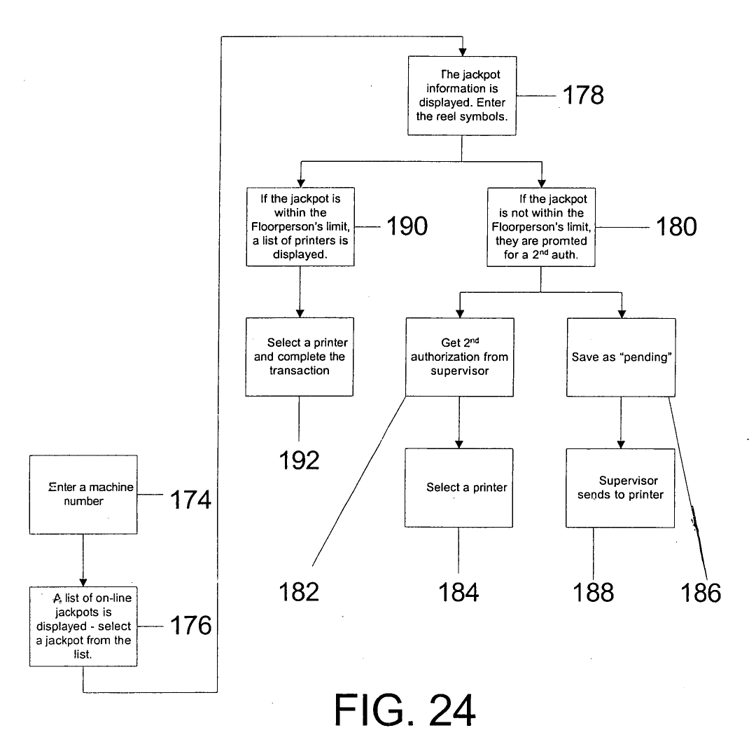

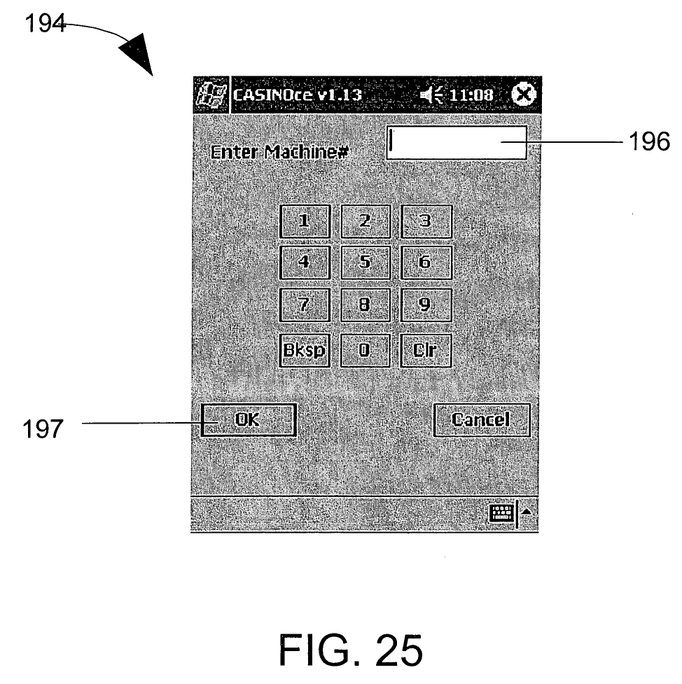

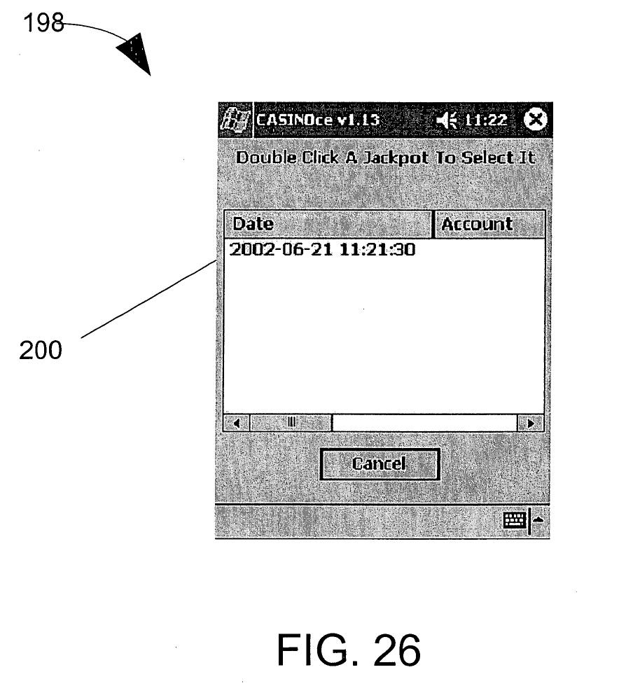

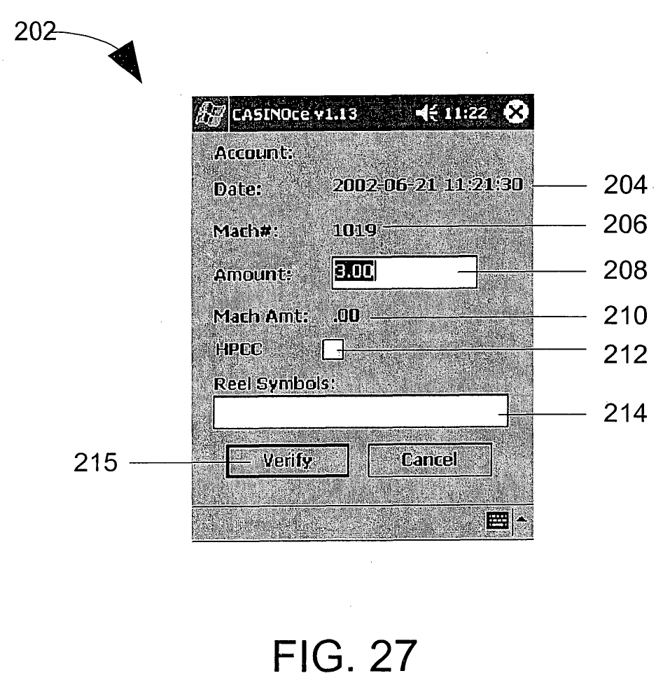

Returning again to FIG. 6, if a player has won a jackpot on a gaming machine and a user desires to process a jackpot, the user selects jackpots option 56 with the data entry system. FIG. 24 shows a flow diagram of the method for processing jackpots in accordance with the present invention. The method for processing jackpots is similar to the method for processing hopper fills described above. After the user selects jackpots options 56, at step 174 the user enters the number of the gaming machine on which the user desires to process a jackpot on a jackpot machine number screen using the data entry system of handheld device 12. An exemplary jackpot machine number screen 194 is shown in FIG. 25. The user enters the jackpot machine number in jackpot machine number section 196 of jackpot machine number screen 194 and then selects OK option 197. Thereafter, the machine number is communicated from handheld device 12 to casino server 20. The jackpots associated with that particular machine are retrieved from database 22 and communicated back to handheld device 12 and, at step 176, are displayed on a jackpot list screen on the display system. An exemplary jackpot list screen 198 is shown in FIG. 26. Only one jackpot should appear in jackpot section 200 and, at step 176, the user selects this jackpot with the data entry system. After the user selects the jackpot listed in jackpot section 200, this selection is communicated from handheld device 12 to casino server 20 and, at step 178, the information about the selected jackpot is retrieved from database 22 and communicated back to handheld device 12 on a jackpot validation screen on the display system. An exemplary jackpot validation screen 202 is shown in FIG. 27. The information listed on jackpot validation screen 202 includes, but is not limited to the jackpot date 204, the jackpot machine number 206, the machine amount 210, and hand pay cancel credit 212, which indicates whether the machine indicated that the jackpot signal was indeed a jackpot or the result of a player cashing out credits which exceeded a reasonable amount of money to be dispensed by the machine based on the hopper size. At step 178, in order to verify the jackpot information, the user enters the amount of the jackpot in jackpot amount section 208 and enters the reel symbols in reel symbol section 214 using the data entry system. Thereafter, the user selects the verify option 215 of the jackpot validation screen 202. This information is then communicated to casino server 20 and stored on database 22.

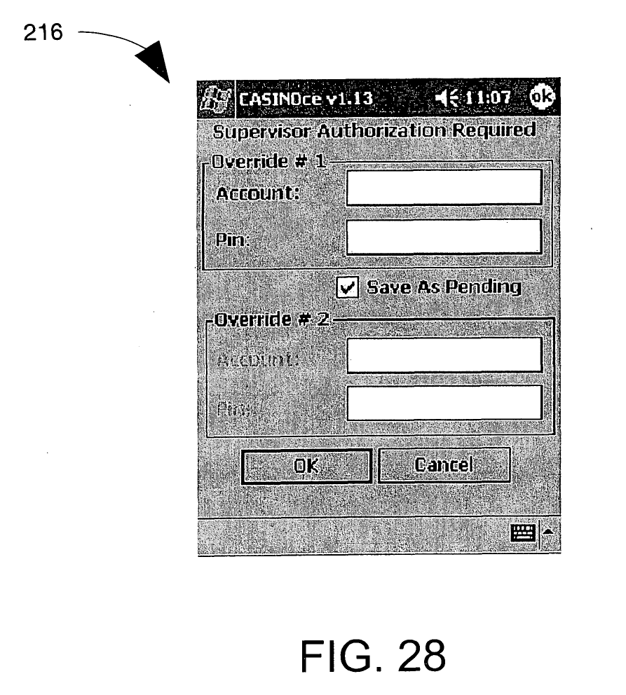

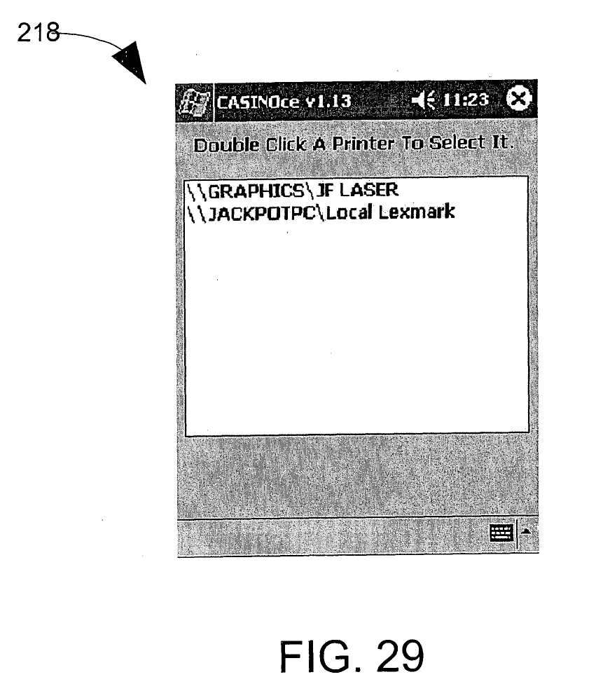

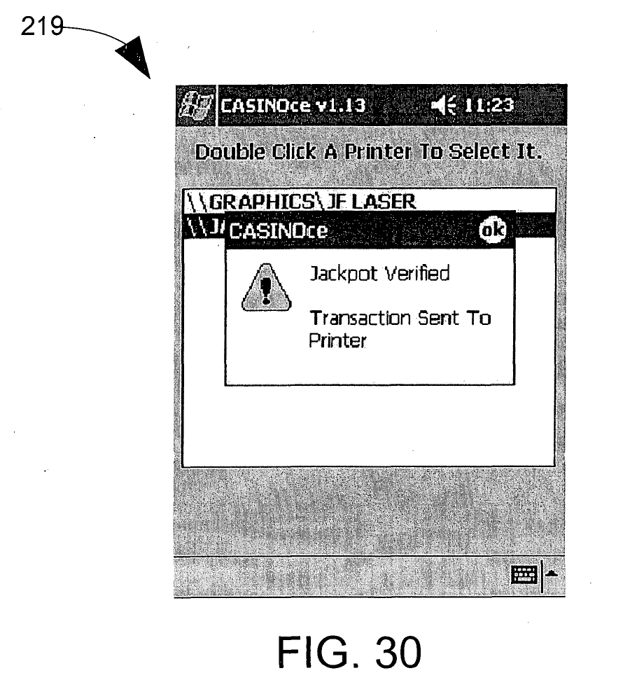

The casino may place a limit on the amount of the jackpot a casino employee may process. This information is stored on database 22. If the jackpot amount is higher than the amount of the jackpot that the user is authorized to process, at step 180, casino server 20 will communicate this information to the user on the display system by prompting the user for the approval of a supervisor on a jackpot supervisor authorization screen. FIG. 28 shows an exemplary jackpot supervisor authorization screen 216. After the user is prompted for the approval of a supervisor, the user can either get a supervisor to immediately authorize the payment of the jackpot at step 182, or, if a supervisor is not readily available, the user can save the transaction as pending at step 186. If the supervisor immediately authorizes the transaction at step 182, the supervisor's authorization is communicated to casino server 20 and stored on database 22. Casino server 20 then communicates a list of printers at each of the cages at which the jackpot information may be printed to handheld device 12 on a jackpot printers screen. An exemplary jackpot printers screen 218 is shown in FIG. 29. At step 184, the user then selects the printer at which the user desires the verified jackpot information to be printed using the data entry system. After the user selects a printer, the user is notified that the jackpot fill information has been verified and sent to the selected printer on a jackpot verified screen. An exemplary jackpot verified screen 219 is shown in FIG. 30. The cage personnel review the verified jackpot information before giving the user any money. After the verified jackpot information is printed at a cage, the user either pays the winning player the jackpot amount from the wallet he or she is carries, or, if the user does not have enough money in his or her wallet, the user goes to the cage at which the verified jackpot information was printed in order to receive the jackpot amount. If the user paid the jackpot from his or her wallet, the user goes to the cage to replenish the amount of money paid to the winning player from the wallet.

If, however, a supervisor is not readily available, at step 186, the user may elect to save the jackpot transaction as pending on jackpot supervisor authorization screen 216. Thereafter, the supervisor can authorize the jackpot transaction on his or her own handheld device 12 on jackpot supervisor screen 216. After the supervisor authorizes the transaction, the authorization is transferred to casino server 20 and stored on database 22. At step 188, the supervisor will then be shown a jackpot printers screen 218 from which to select a printer at which to print the verified jackpot information. The supervisor is then shown jackpot verified screen 219. The supervisor can communicate the printer location to the user by using communications option 48 described above, or by personal or radio communication on the casino floor. The user then pays the jackpot as described above.

If the jackpot amount is within the user's authorized limit, at step 190, the user is shown jackpot printer screen 216. At step 192, the user then selects the printer at which he or she desires to print the verified jackpot information and is then shown jackpot verified screen 219. Thereafter, the user pays the jackpot as described above.

Processing jackpots in accordance with the present invention is advantageous over the prior art in numerous ways. Handheld device 12 allows the user to verify the jackpot information at the gaming machine itself instead of having to use a remote hardwired employee computer terminal or radio the dispatch personnel to verify the jackpot information. This saves the user much time as it is time consuming for the user to receive verification from the dispatch personnel, especially if the casino is busy. As the verification process is much shorter, the gaming machine is operational for a longer time period which leads to increased revenue for the casino. In addition, the player is paid the jackpot amount in a more timely manner, which further develops the player's loyalty to the casino. Further, if supervisor approval is necessary, the user can save the transaction as pending if a supervisor is not available. Thus, the employee can continue other activities instead of wasting time waiting for the supervisor. Also, as the present invention eliminates the need for a verification department, the casino realizes a decrease in payroll expenses.

Player Tracking Services

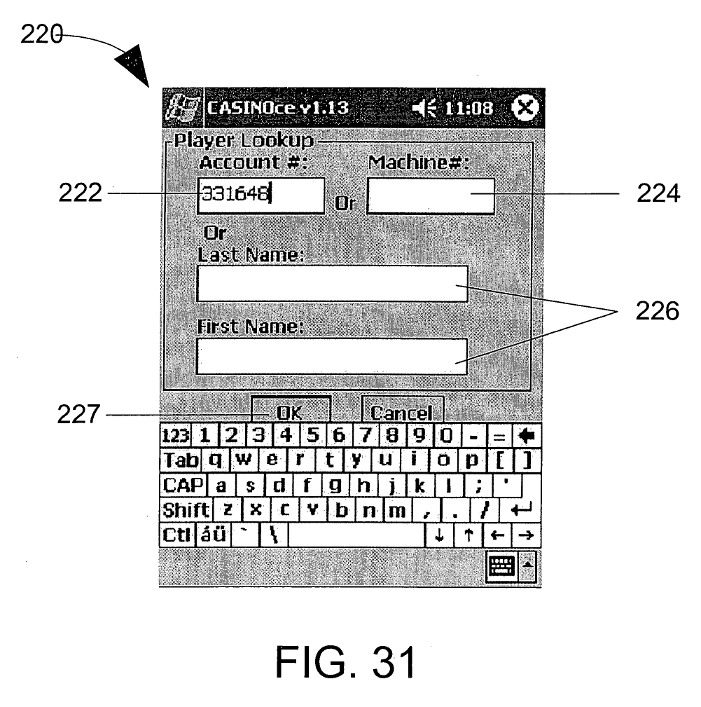

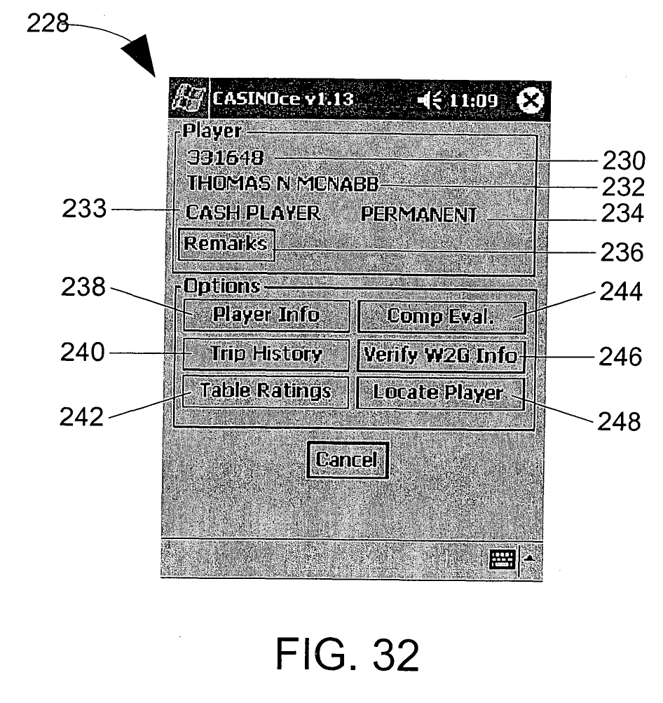

Referring back to FIG. 5, if the user selects player tracking services option 40 using the data entry system, a player lookup screen is displayed on the display system. An exemplary player lookup screen 220 is shown in FIG. 31. In this embodiment, in order to utilize the player tracking services option 40, the user enters one or more of three types of information. Specifically, using the data entry system, the user enters one or more of the following: the player's customer loyalty program account number in account number section 222, the gaming machine number in gaming machine number section 224, or the name of the player in the player name section 226. After the user enters at least one of these pieces of player lookup information, the user selects OK option 227 and the information is communicated to casino server 20. In another embodiment of the present invention player tracking services option 40 may be utilized by entering other identifying information about the player besides the player's account number, machine number, or name. The player's general information is retrieved from database 22 and is communicated back to the user on the display system of handheld device 12 on a player tracking services option menu. FIG. 32 shows an exemplary player tracking services options menu 228. The general player information displayed on player tracking services options menu 228 includes, but is not limited to the player's account number 230, the player's name 232, the player's type 233, and the player's membership level 234. Player tracking services options are also displayed on player tracking services options menu 228. In this embodiment, seven slot tracking service options are presented to the user, namely, player remarks option 236, player information option 238, trip history option 240, table ratings option 242, comp evaluation option 244, W-2G information option 246, and locate player option 248. It will be appreciated by those of skill in the art that additional player tracking service options may be presented to the user. The user selects which player tracking service the user desires to perform using the data entry system of handheld device 12.

1. Player Remarks.

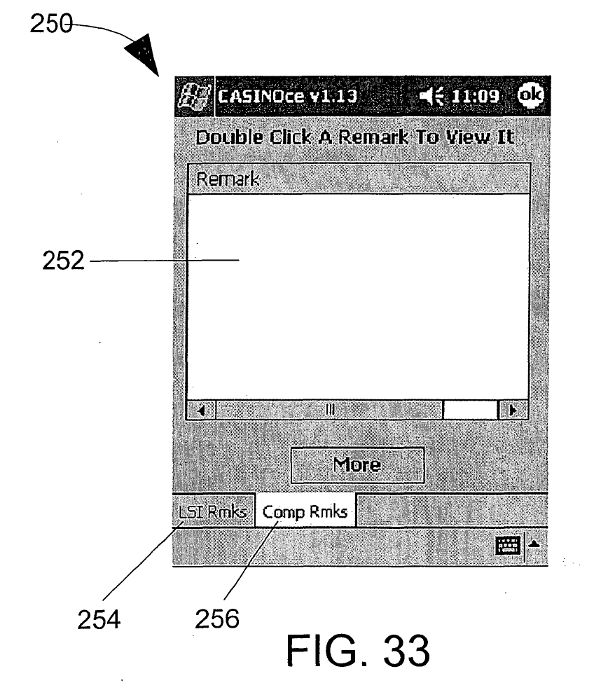

If the user desires to view player remarks on handheld device 12, the user selects player remarks option 236 via the data entry system. This selection is communicated to casino server 20 and remarks about the player are retrieved from database 22 and communicated back to handheld device 12 and displayed on the display system via a player remarks screen. FIG. 33 shows an exemplary player remarks screen 250. The user then selects the player remark that the user desires to review from the remarks section 252 using the data entry system. These remarks are used to provide personalized service to player's in a timely manner in order to develop the player's loyalty to a particular casino. In this embodiment, the user can view two types of player remarks, namely, general player remarks and remarks about comps that may be available to a player. The user selects which type of information to view by selecting the general player remarks tab 254 or the comp remarks tab 256, respectively, with the data entry system. It will be appreciated by those of skill in the art that the user may view other types of player remarks as long as the remarks have been stored on database 22. It will also be appreciated by one of ordinary skill in the art that the player remarks could also be arranged so that the player remarks are displayed on one screen or any of a plurality of screens.

As the remarks are used to provide better service to the player in order to develop the player's loyalty to a particular casino, several efficiencies and advantages are realized by providing users with access to player remarks at any location on the casino floor, including at the player's location. The present invention eliminates the risk that a casino employee will miss opportunities to provide personalized services to the player while the employee tries to access the player remarks at an employee computer terminal. Instead, the employee can look up the player remarks near a player's location and then provide services based on those comments immediately. Further, as the employee has access to the player's remarks at any location on the casino floor, the employee does not have to leave the player's location and navigate the crowded casino floor in order to utilize the employee computer terminals. Therefore, the employee has more time to provide personalized services to more players. In addition, as the employee provides the personalized services to players in a more timely manner, the players are more likely to be satisfied with these services and return to the casino.

2. Player Information.

Returning to FIG. 32, if a user desires to view information about a player, the user selects the player information option 238 with the data entry system of handheld device 12. Player information will be available if the player has signed up for a customer loyalty program, or if the casino obtained the information in some other manner and the information was communicated to casino server 20 and stored on database 22. This selection of player information option 238 is communicated to casino server 20 and the player's information is retrieved from database 22 and communicated back to handheld device 12. The selected player's retrieved information is displayed on the display system. If the selected player's account is a joint account, the cumulative joint account information is displayed on this player information screen. In this embodiment, the user can view three types of player information, namely, general player information, player address information, and information about the customer loyalty program to which the player belongs, if any, including the player's gambling statistics. In one embodiment, if the player has a joined account (such as a husband and wife) the user can view the player's individual information, as well as the player information of all accounts joined to the selected player's account. It will be appreciated by those of skill in the art that the user may view other types of player information as long as the player information has been stored on database 22. This information may include, but is not limited to the player's credit line, credit summary, and cash transactions reporting information, and applicable restrictions. It will further be appreciated by one of ordinary skill in the art that the player information could also be arranged so that the player information is displayed on one screen or any of a plurality of screens.

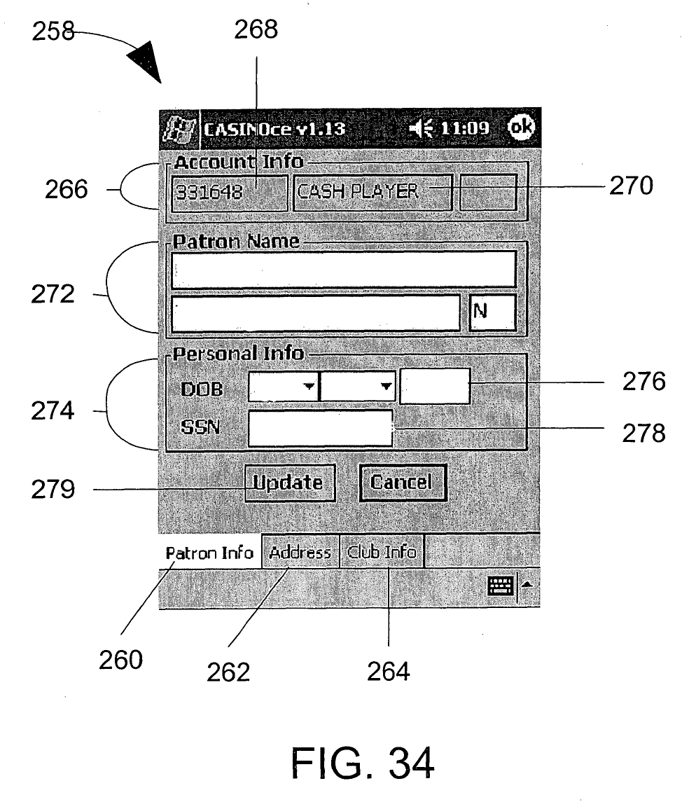

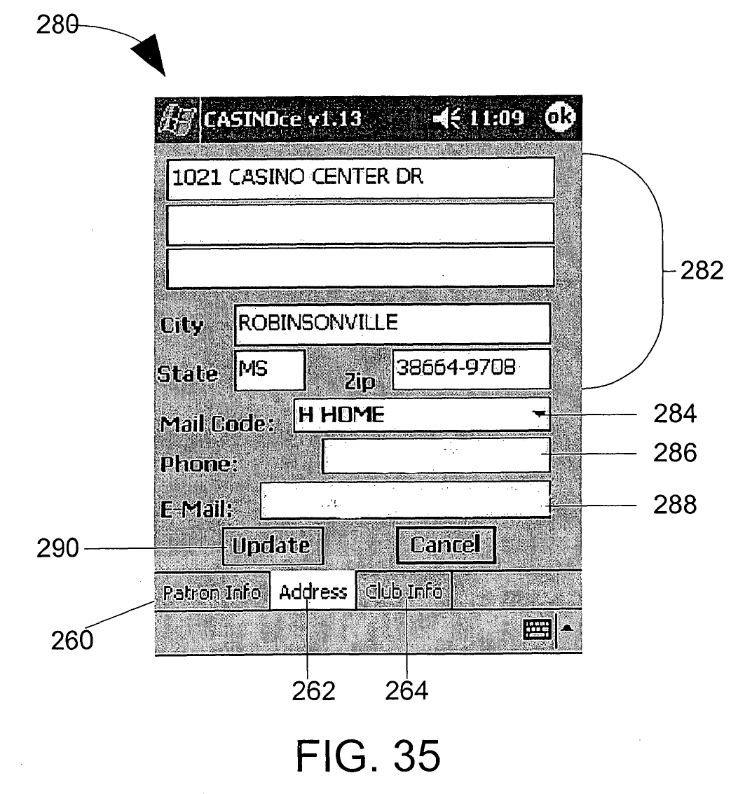

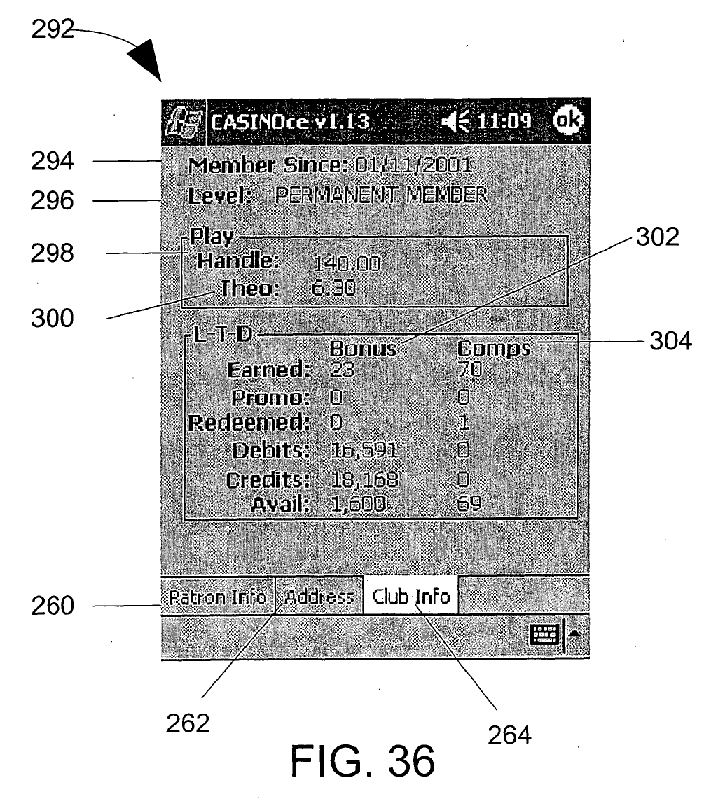

The three types of player information are located on three different screens, namely a general player information screen, a player address information screen, and a customer loyalty club screen. An exemplary player information screen 258 is shown in FIG. 34. An exemplary player address information screen is shown in FIG. 35. An exemplary customer loyalty program screen 292 is shown in FIG. 36. The user selects which screen to view by selecting the general player information tab 260, the player address information tab 262, or the customer loyalty program tab 264, respectively.

General player information screen 258 contains general player information including, but not limited to the player's account information 266 which includes, but is not limited to the player's account number 268, and the player's type 270; the player's name 272; and the player's personal information 274 which includes, but is not limited to the player's date of birth 276 and social security number 278. A user may also update any of the general player information by selecting update option 279. After the user updates the general information, this updated information is communicated to casino server 20 and stored on database 22.

Player address information screen 280 contains player address information including, but not limited to the player's mailing address 282, the mail code associated with the player's mailing address 284, the player's telephone number 286, and the player's electronic mail address 288. The user may also update this information using update option 290, as explained above.

Customer loyalty program screen 292 displays information associated with the customer loyalty club and statistics related to the player's gambling activities. This information includes, but is not limited to the date the player became a member of the customer loyalty program 294; the player's membership level 296; and the statistics about the player's gambling activities which include, but are not limited to the player's handle 298, the player's theoretical win profile 300, the player's accumulated points 302, and the player's comp information 304. A player's “handle” refers to the total amount of money put at risk by the player during a gaming session.

In one embodiment, the user may also view player credit information for players that have a line of credit at the casino on a customer credit information screen (not shown). The information displayed on the customer credit information screen may include, for example, the total amount of the player's line of credit, what amount of the player's line of credit has been used by the player, and what amount of the player's line of credit is still available to the player.

It will be appreciated by one of ordinary skill in the art that in one embodiment of the present invention the user can use player information option 238 to enter information about a new player in order to enroll the player in a customer loyalty program. This information is then communicated to casino server 20 and stored on database 22. It will also be appreciated by one of ordinary skill in the art that handheld device 12 may further comprise a printer device in order that the user can utilize handheld device 12 to enroll a player in the casino's customer loyalty program and print the associated card for the player at the player's location anywhere on the casino floor, including at a gaming machine or table. In another embodiment of the present invention, application server 18 or casino server 20 may contain an address hygiene database, which database is well known in the art. If a user inadvertently enters a “dirty address” for a player, meaning an address that is misspelled, contains an incorrect zip code, etc., when the dirty address is communicated to application server 18 or casino server 20, the address hygiene database automatically corrects the dirty address. Thereafter, the corrected address is stored on database 22 and is communicated to handheld device 12 and displayed on the display system.

Numerous advantages are associated with player information option 238. First, as discussed above, casino employees do not have to leave the location of the casino's valuable customers and risk losing an opportunity to provide personalized services to the player in order to access the player's information and thereafter provide such services, such as comps, to the player. As the comps are awarded to players in a more timely manner, the players' loyalty to the casino is further developed. Further, as the employee can use handheld device 12 to enter information about a new player and update a carded player's information at the player's gaming location, the information entered by the employee is more accurate as the employee does not have to remember the information and then find an employee computer terminal at which to enter the information. Also, players are more willing to sign up for a casino's customer loyalty program because it requires no effort on the player's part. The employee can sign the player up for the customer loyalty program while the player continues his or her gambling activities and the casino can begin its marketing efforts with respect to the newly enrolled player.

3. Trip History.

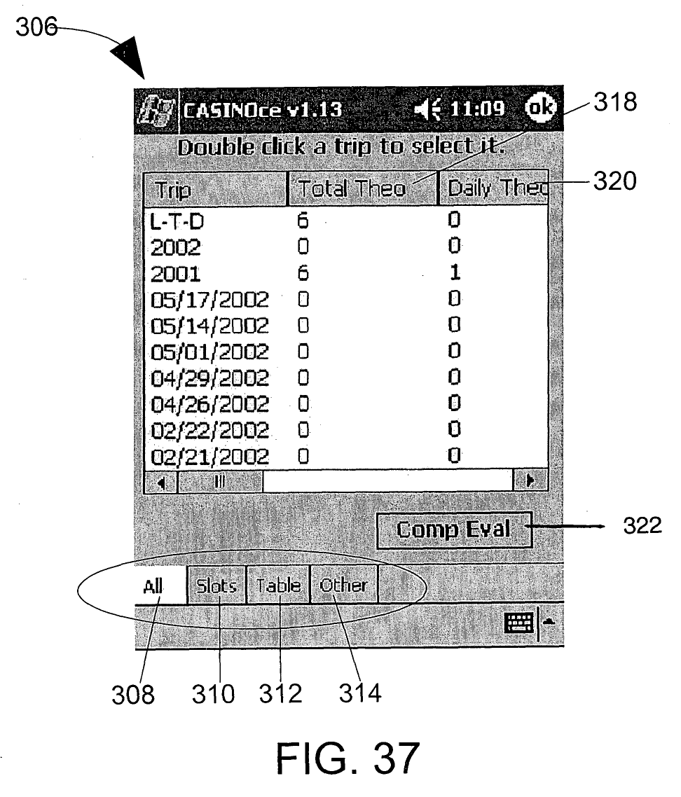

Referring back to FIG. 32, if a user desires to view a player's trip history information, the user selects trip history option 240 with the data entry system of handheld device 12. This request for trip history information is communicated to casino server 20 and the requested information is retrieved from database 22. This information is then communicated back to handheld device 12 and displayed on the display system on a trip history screen. An exemplary trip history screen 306 is shown in FIG. 37.

In one embodiment of the present invention, the user can view four types of trip history information; namely, the player's trip histories for all the player's gambling activities, the player's slot machine trip histories only, the player's table game trip histories only, and the player's trip histories that include the player's gambling activities other than at slot machines or gaming tables. In one embodiment, the four types of trip history information are viewed on four different screens. The user selects which screen to view by selecting the cumulative trip history tab 308, the slot trip history tab 310, the table game trip history tab 312, and the other trip history tab 314. The trip history information includes, but is not limited to total theoretical win 318, daily theoretical win 320, as well as coin in, coin out, time played, actual win/loss, points earned and skill level. The trip history information is available for each individual trip, as well as for each year and the player's life to date cumulative information. The user may also view the player's comp evaluation by selecting the comp evaluation option 322.

It will be appreciated by one of ordinary skill in the art that the trip history information could also be arranged so that the trip information is displayed on one screen or any of a plurality of screens. It will be also be appreciated by those of skill in the art that the user may view other types of trip history information as long as the trip history information has been stored on database 22.

Again, it is advantageous to provide the player's trip history information to casino employees anywhere on the casino floor. Employees provide personalized services, such as comps, to valuable player's based on the player's trip history information. Providing this information to the employee via a wireless, handheld device, eliminates the risk that the player will leave the casino or change gambling locations while the employee tries to access the player's remarks at a static employee computer terminal. Instead, the employee can look up the player's trip history information near a player's location and then provide services based on those comments immediately. Further, the player's satisfaction level increases as the employee is much more responsive with respect to providing the player with personalized services. The present invention also saves the employee time as the trip history information is displayed via the handheld device he or she carries instead of having to find an employee computer terminal.

4. Table Ratings.

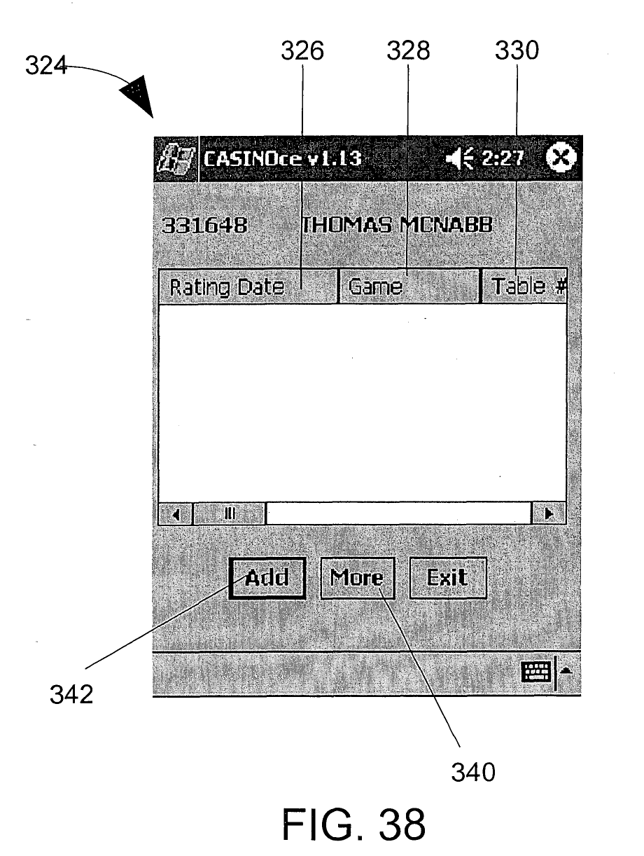

Referring again to FIG. 32, if a user desires to view a player's table ratings or add a new table rating based on observed table play, the user selects the table ratings option 242. This selection is communicated to casino server 20 and the player's table ratings are retrieved from database 22. The table ratings are communicated back to handheld device 12 and displayed on the display system via a table ratings screen. FIG. 38 shows an exemplary table ratings screen 324. The information displayed on table ratings screen 324 includes, but is not limited to the table rating date 326, the type of table game on which the rating was based 328 (for example, blackjack or poker), the number of the table game 330, average wager, time played, game speed, player proficiency, theoretical win, and actual win. The user may view additional table ratings for a player by selecting more option 340. It will be also be appreciated by those of skill in the art that the user may view other types of table rating information as long as the table rating information has been stored on database 22. Thus, handheld device 12 allows casino employees to provide access to the player's table ratings and provide personalized services based on the table ratings at the player's location.

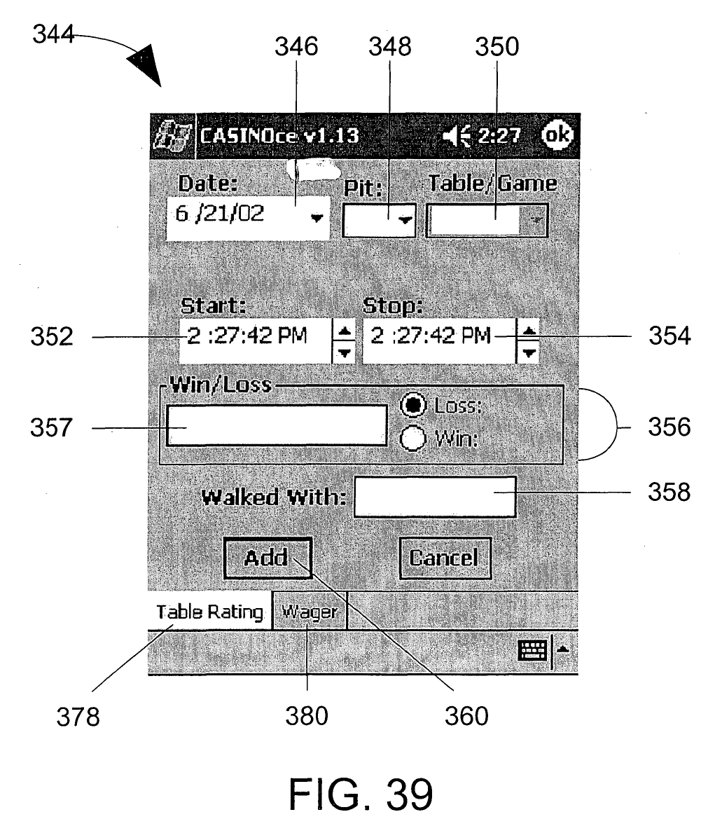

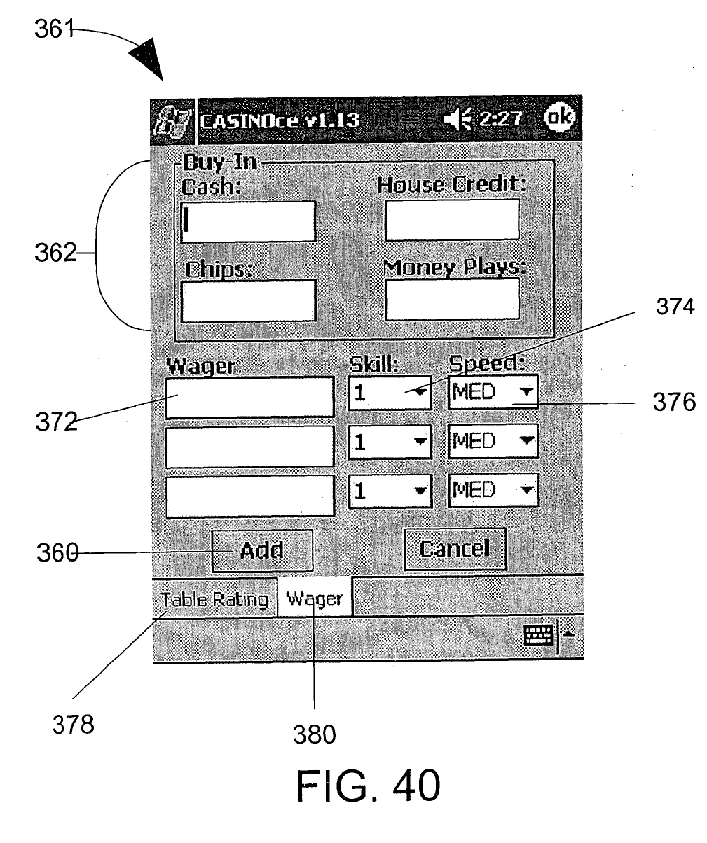

In addition, if the user is observing the table play of a player, the user may enter a new table rating for a player by selecting add option 342. In one embodiment, if the user desires to add a table rating, the user completes two types of information about the player's table game activities, namely table rating information and wager information. An exemplary table rating entry screen 344 is shown in FIG. 39. FIG. 40 shows an exemplary wager entry screen 361. The user may rotate between these screens by selecting the table rating tab 378 and the wager tab 380, respectively. It will be appreciated by one of ordinary skill in the art that the table rating information can be arranged so that it is displayed on one screen or any of a plurality of screens.

First, with regard to table rating entry screen 344, based on the observations of the user, the user enters the following information about the observed table play using the data entry system: the date of the table play in table play section 346; the number of the pit in pit section 348; the number of the table in table section 350; the starting time of the observed table play in starting time section 352; the stopping time of the observed table play in stopping time section 354; whether the player won or lost in win/loss section 356; the amount of the win or loss in amount section 357; and the amount of money the player left the table with in walked with section 358.

Second, with regard to wager entry screen 361, using the data entry system the user also enters the following information about the observed table play: the player's buy-in amount in buy-in section 362; the player's wagers in wager section 372; the player's skill levels in skills section 374; and the player's speeds in speed section 376. After the user completes the information on table rating entry screen 344 and wager entry screen 361, the user may communicate the table rating information to casino server 20 by selecting the add option 360 from either the table rating entry screen 344 or the wager entry screen 361. Thereafter, casino server 20 generates a table rating for the player and this table rating is stored on database 22. Thereafter, the user may retrieve this table rating from database 22 by selecting table rating option 242.

Several advantages and efficiencies are realized by allowing floor personnel to enter table ratings via handheld device 12. First, as the floor personnel can enter the table ratings location of the table games being observed, real time table ratings are available for a player for the purpose of providing personalized services to valuable players. For example, if a valuable table game player just lost a large sum of money at a table game, casino employees want this information so that they can provide a comp to the valuable player before he or she leaves, thus lessening the impact of the loss on the player. Further, as the floor personnel both observe the table play and enter the table rating, only one casino employee is needed to generate the table rating.

5. Comp Evaluation.

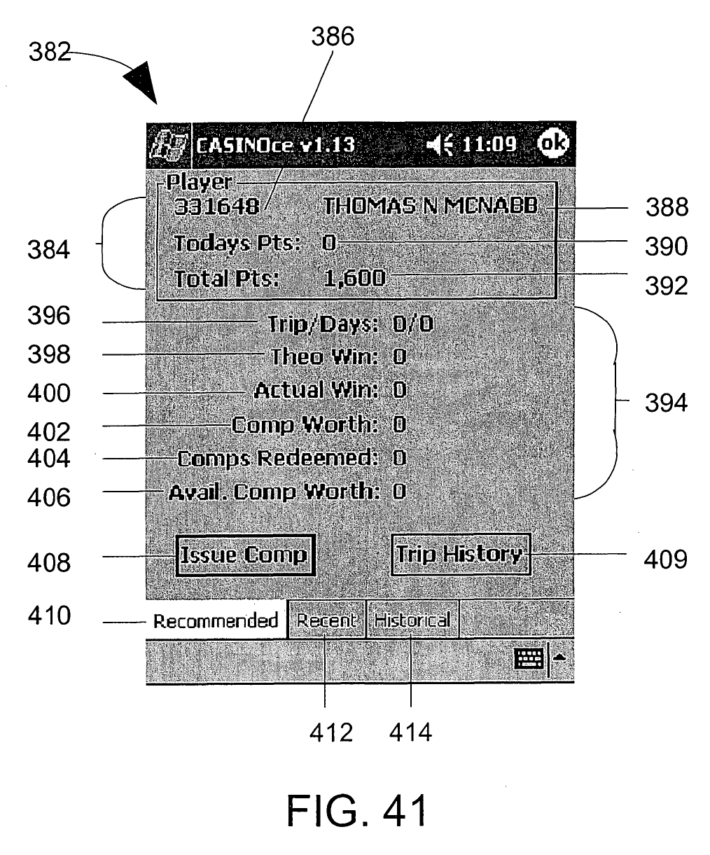

Returning to FIG. 32, if a user desires to view a player's comp evaluation and issue a comp, the user selects comp evaluation option 244. This selection is communicated to casino server 20 and the player's comp evaluation is retrieved from database 22 and communicated back to handheld device 12. The comp evaluation is displayed on the display system via a comp evaluation screen. FIG. 41 shows an exemplary comp evaluation screen 382. Comp evaluation screen 382 contains general comp information 384 including, but not limited to the player's account number 386, the player's name 388, the points the player has accumulated that day 390, and the player's total points 392. Comp evaluation screen also includes more detailed comp information including, but not limited to the number of the player's trips and the number of days the trips spanned 396, the player's theoretical win profile 398, the player's actual win profile 400, the player's comp worth 402, the comps the player has redeemed 404, and the worth of the player's available comps 406. In addition, by selecting trip history option 409 with the data entry system, the user may utilize trip history option 240, as described above. In one embodiment, the comp evaluation information set forth on comp evaluation screen 382 can be viewed from three points of view, namely, the recommended comp information, the player's recent comp information, and the player's historical comp information. Using the data entry system, the player can select from which point of view to review the comp evaluation by selecting recommended comp tab 410, recent comp tab 412, and historical comp tab 414, respectively.

It will be appreciated by one of ordinary skill in the art that the comp evaluation information could also be arranged so that the comp evaluation information is displayed on one screen or any of a plurality of screens. It will be also be appreciated by those of skill in the art that the user may view other types of comp evaluation information as long as the comp evaluation information has been stored on database 22.

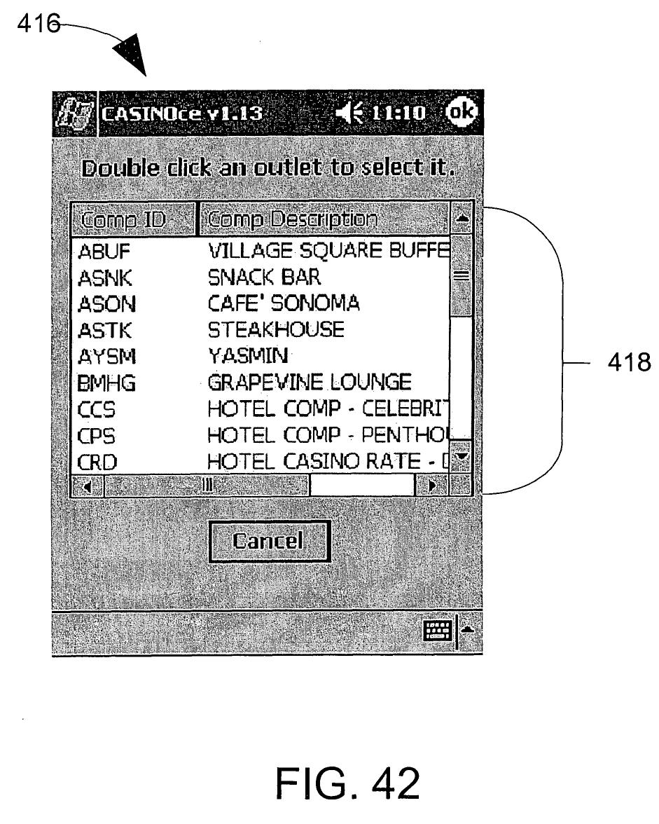

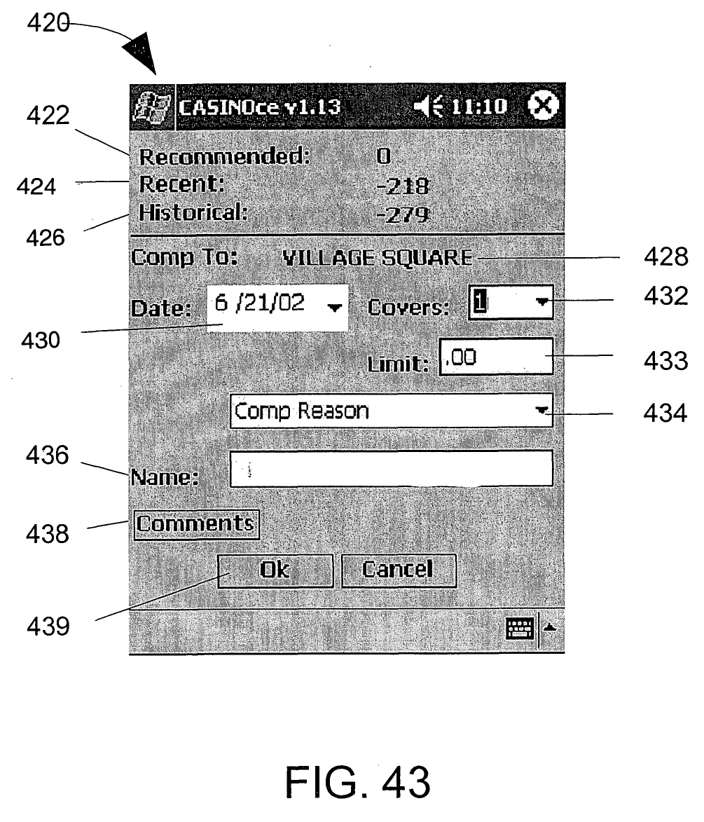

After the user has reviewed the player's comp evaluation information, if the user desires to issue the player a comp, the user selects issue comp option 408. Thereafter, a list of comps is shown to the user on the display system of handheld device 12 via a comp description screen. FIG. 42 shows an exemplary comp description screen 416. Comp description screen 416 contains a list of comps 418 that the user may issue a player. The comps include, but are not limited to free meals at casino restaurants, free hotel rooms, free entertainment event tickets, free airplane tickets, etc. Using the data entry system, the user selects what type of comp the user wishes to issue the player. The user is then shown a comp information entry screen through which the user enters information about the comp being issued. An exemplary comp information entry screen 420 is shown in FIG. 43.

Exemplary comp information entry screen 420 displays the recommended available comp worth of the player 422, the recent available comp worth of the player 424, and the historical available comp worth of the player 426. The type of comp selected by the user on the comp description screen 416 is displayed in comp section 428. The user then enters the date the comp is issued in date section 430, the number of individuals covered by the comp in individuals section 432, the dollar limit of the comp in limit section 433, and the reason for the comp in comp reason section 434. The name of the customer is displayed in name section 436. The user may also select the comments section 438 to enter any special instructions regarding the comp requested by the player.

It will be appreciated by one of ordinary skill in the art that the user could enter other additional information on comp information entry screen 420. For example, the user could enter the location of the seats the user desired to comp the player for an entertainment event such as a concert. It will also be appreciated by one of ordinary skill in the art that in one embodiment of the present invention the reason for the comp being issued can be selected from a menu of comp reasons. For example, if the comp is outside the established parameters for the comp amount to which a player is entitled, the user selects the exceptions option from the menu associated with comp reason section 434. If the comp is an exception, the user is then shown a comp exception screen (not shown) and, using the data entry system, the user enters comments regarding why the comp was issued on the comp exception screen.

After the user has completed comp information entry screen 420, and, if applicable, comp exception screen, the user selects OK option 439 and the information is communicated to casino server 20 and stored on database 22. Thereafter, in one embodiment, the user is also given the option on the display system of printing a ticket representing the comp or selecting a paperless comp. If the user desires to print a ticket representing the comp, the user is shown a list of printers on which the ticket can be printed. Thereafter, the user selects the desired printer and retrieves the ticket and gives it to the comped player for redemption. It will be appreciated by one of ordinary skill in the art that handheld device 12 may itself further comprise a printing device.

If the user selects the paperless comp option, the comp information is transferred to a remote point of sale terminal at the location where the comp is to be redeemed through systems well known in the art. The comp is then displayed on the display system associated with the remote point of sale terminal. The player then simply presents his or her player's card at the location where the comp is to be redeemed and is admitted to the location.

Thus, the present invention allows casino employees to access comp information and issue comps based on that information anywhere on the casino floor. Employees do not have to leave the player's location to use a static, employee computer terminal to issue the comp and risk that the player will leave the casino or change locations while the employee is trying to comp the player. This advantage is extremely important as comping is one of the most effective ways to develop a customer's loyalty to a particular casino. Further, issuing comps in accordance with the present invention allows the employee to meet player requests in a much more timely manner, thus increasing the chance that the player will return to the casino.

6. W-2G Verification and Processing.

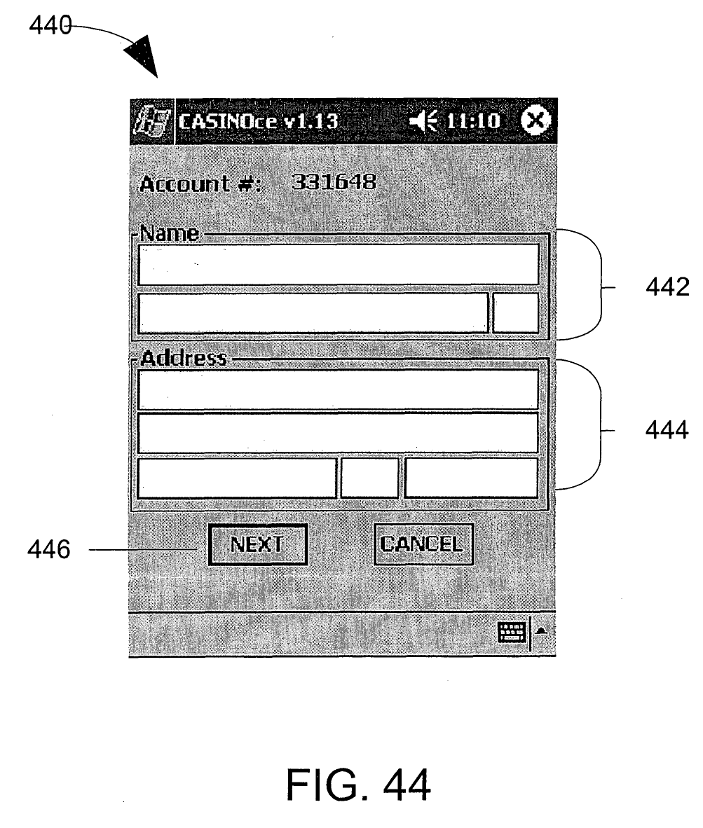

Returning to FIG. 32, if a user desires to verify a player's W-2G information, using the data entry system, the user selects verify W-2G information option 246. As discussed above, casinos must submit a Form W-2G to the IRS if a player wins a certain amount of money from the casino. The Form W-2G must contain certain information including, but not limited to the winning player's name, address, two sources of identification, the nationality of the player, the signature of the player, and a photograph of the player. After the user selects verify W-2G information option 246, the user's selection is communicated to casino server 20 and the player's W-2G information is retrieved from database 22 and communicated back to handheld device 12. The W-2G information is displayed on the display system via a W-2G information screen. FIG. 44 shows an exemplary W-2G information screen 440. While at the player's gaming location, the user can use handheld device 12 to verify the player's name 442 and the player's address 444. If the information is missing or incorrect, the user can use the data entry system to enter or correct the player's W-2G information.

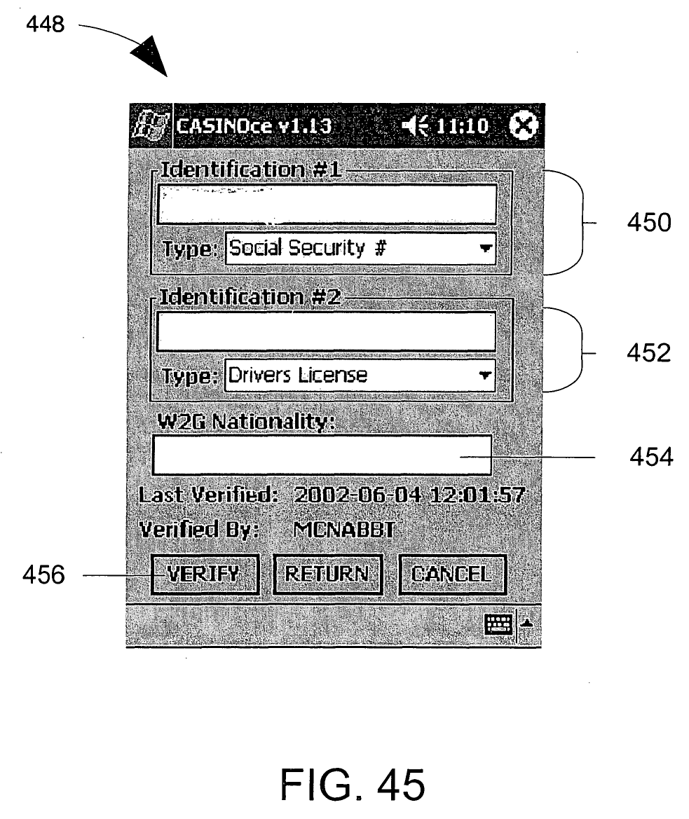

After the user verifies the player's W-2G information on W-2G information screen 440, the user selects the next option 446 to verify additional W-2G information on a W-2G identification screen. An exemplary W-2G identification screen 448 is shown in FIG. 45. While at the player's gaming location, the user can verify the player's first source of identification 450, the player's second source of identification 452, and the player's W-2G nationality 454. Again, if the information set forth on W-2G identification screen 448 is missing or incorrect, the user can use the data entry system to enter or correct the player's W-2G identification information. After the user has verified the information on W-2G information screen 440 and W-2G identification screen 448, the user selects the verify option 456 with the data entry system and the verified information is communicated to casino server 20 and retrievably stored on database 22. Thus, by using handheld device 22, the user can verify the player's W-2G information at the player's location when the player wins enough money to trigger the W-2G requirements. In this embodiment, the user then proceeds to an employee computer terminal to enter the additional required W-2G information, such as the amount of money the player won. After all required information is entered, the information is communicated to casino server 20 and retrievably stored on database 22. The user also prints a W-2G certificate containing the verified and completed information for the player to sign. The player's photograph can be obtained from the surveillance cameras.

In another embodiment of the present invention, however, when the user selects verify W-2G information option 256 and communicates this selection to casino server 20, the information retrieved from database 22 and communicated back to handheld device 20 on the display system includes all required W-2G information, including the amount of money the player won. Also, as discussed above, in an embodiment of the present invention handheld device 20 is sensitive to pressure and contains a digital camera. Therefore, handheld device 12 may be used to capture the winning player's signature, as well as the winning player's photograph. Thus, the user can generate a completed Form W-2G from the player's location. As illustrated above, the present invention streamlines the W-2G process, thus allowing the casino personnel to complete the Form W-2G in a much more timely manner and players to continue their gambling activities.

7. Locate Player.

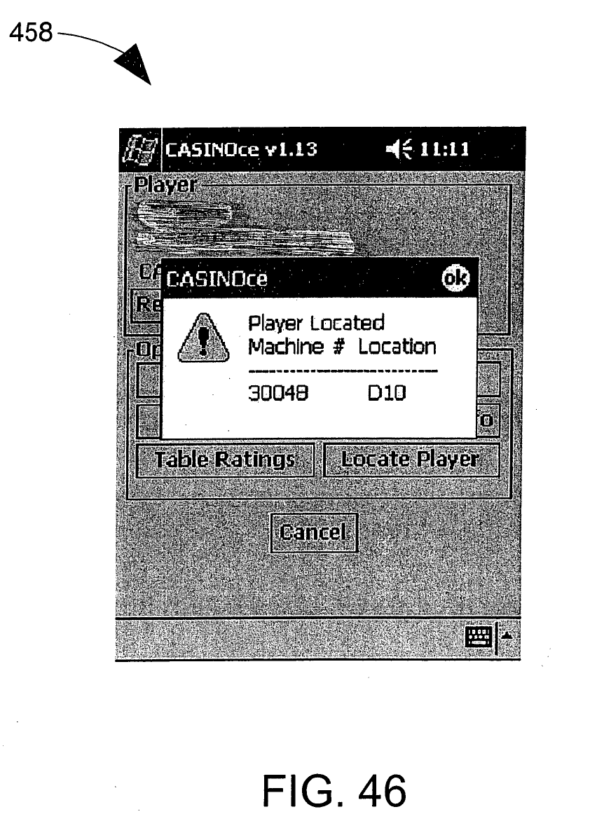

Referring back to FIG. 32, if the user wishes to locate a player on the casino floor and knows the name or account number of a player, the player selects locate player option 248 using the data entry system. This selection is then communicated to casino server 20. As long as the player the user wishes to locate has his or card inserted into a card reader, the location of the player can be retrieved from database 22 and communicated back to handheld device 12 and displayed on a locate player screen. An exemplary locate player screen 458 is shown in FIG. 46. Thus, the user can locate a valuable player very quickly and then provide specialized services to the player in order to increase the player's loyalty to a particular casino. Another advantage of having all player information available to casino employees, including the location of a player, on a handheld device that can be used anywhere on the casino floor is that the need for static employee computer terminals is eliminated. Therefore, more room exists on the casino floor for revenue generating gambling activities.

Other Transactions

It will be appreciated by one of ordinary skill in the art that system 10 may be used to conduct numerous other casino transactions at any location on the casino floor in real time. The only requirement is that handheld device 12 be in bi-directional communication with casino server 20 through a wireless communication system. Discussed below are additional examples of the capabilities of the present invention. These examples are simply illustrative, and not exhaustive of the capabilities of the present invention.

First, the user may also be given the option of reviewing the coupons and other offers that the casino has sent to a player, as well as the player's entire promotional history. This selection is communicated to casino server 20 and the requested information is retrieved from database 22, communicated back to handheld device 12, and displayed on the display system. In one embodiment, the coupons and offers are arranged by type (such as cash, room, food, entertainment) and by status (such as available, expired, redeemed). The user can then select an offer or coupon and redeem it for the player even if the player forgot his or her coupons or offers. Further, the present invention is advantageous over the prior art even if the player remembers to bring his or her offers or coupons to the casino. As discussed above, these offers and coupons are bar coded. In one embodiment, handheld device 12 comprises a bar code reader. Therefore, as is well known in the art, the user may use the bar code reader to redeem the player's offers or coupons at the player's location anywhere on the casino floor instead of the player having to do so himself or herself at a player kiosk or customer service center, such as a cage or club booth.

As discussed above, in one embodiment of the present invention, handheld device 12 is sensitive to pressure and may be used to capture signatures as is well known in the art. Currently, in all gaming jurisdictions, a card, commonly referred to as a “meal card,” sits inside gaming machines. Gaming regulations require that every employee opening the gaming machine must sign the meal card and state the reason for opening the machine. It will be appreciated by one of ordinary skill in the art that handheld device 12 can be used to capture the employee's signature and to enter the reason for the employee opening the machine. Thereafter, this information can be communicated to casino server 20 which can run reports on this information through systems well known in the art. This approach is advantageous over the prior art as it was difficult and time consuming to run such reports from the written meal cards. The reports generated by casino server 20 may detail, for example, a list of the machines that were opened due to malfunctions to determine if a machine is constantly malfunctioning and needs to be replaced. This information and any resulting reports are then stored on database 22. In addition, handheld device 12 can also be used to retrieve and display this information and any resulting reports from database 22 so that casino employees can view it any location on the casino floor.

In another embodiment, the technical gaming machine personnel may use the data entry system of handheld device 12 to enter service records and activities regarding gaming machine malfunctions and repairs instead of using paper records. This information would then be communicated to casino server 20 and stored on database 22. In addition, through systems well known in the art, casino server 20 can join this gaming machine information with the repair information in order to generate reports about the overall performance of the gaming machine. It is difficult and time consuming to run such reports with the written service records. These reports are also stored on database 22. In addition, handheld device 12 can also be used to retrieve and display the service records and any resulting reports from database 22 so that casino employees can view it any location on the casino floor.

In another embodiment of the present invention, handheld device 12 is used to access “flash reports” that are generated by casino server 20 from information communicated to casino server 20 from a variety of sources including, but not limited to the information polled from the meters associated with gaming machines. A flash report outlines the profitability of the casino floor including, but not limited to information regarding coin in, coin out, jackpots, hopper fills, carded play, uncarded play, actual win, theoretical win, comps and points earned and redeemed information. This profitability information can be sorted by the denomination of gaming machines, a particular gaming machine or bank of machines, floor section, or hour of the day. The flash report also provides comparisons of how the casino floor is currently performing compared with previous averages or optimum values established by the casino. In this embodiment, the user selects a flash report option displayed on the display system. Thereafter, this selection is communicated to casino server 20 via wireless communications system 13 and retrieved from database 22. Thereafter, the flash report is communicated back to handheld device 12 via wireless communications system 13 and displayed on the display system. Thus, the present invention allows users to access the flash report at any location on the casino floor and promptly react to the information contained in the flash report.

In yet another embodiment, the present invention alerts users if a player about which the user is accessing information is in a cash transaction reporting (“CTR”) restricted state. As is well known in the casino industry, the IRS has CTR regulations that require casinos to report (for the purpose of preventing money laundering) certain information about a player and his or her gambling activities if the player has won, lost, or played a certain amount of money in a twenty-four hour period. If a player is in a CTR restricted state, the casino must report the relevant information to the IRS before performing any further transactions with respect to the player including, but not limited to generating additional table ratings for the player. Once the casino submits the CTR information to the IRS, the player is no longer in a CTR restricted state. In many instances, the casino cannot submit the CTR information to the IRS because it is missing information from the player, such as the player's social security number. In this embodiment, if a user attempts to access any information about a player that is in a CTR restricted state with handheld device 12, such as the player's remarks or trip history information, an alert is communicated from casino server 20 to handheld device 12 and displayed on the display system. This alert specifies what CTR information is missing about the player. Thereafter, the user can approach the player and gather the relevant information, such as the player's social security number, and, using the data entry system of handheld device 12, communicate this information to casino server 20, which information is then stored on database 22. As the user is attempting to access information about a player currently gambling on the casino floor, the user is alerted to the player's CTR restricted state while the user is also on the casino floor. Therefore, the user has a much better chance of obtaining any required player information that is missing because the user can quickly approach the player.

Finally, in many gaming jurisdictions, the local gaming regulations require casinos to require a certain amount of money be played through a gaming machine and that the associated meters be captured to show that the gaming machine is properly capturing and processing information to casino server 20 before the gaming machine is allowed on the casino floor for use by players. Specifically, in many jurisdictions, the regulations require that ten coins and one bill to be played prior to allowing the gaming machine on the casino floor. This test is commonly referred to as a “ten coin test.” In these jurisdictions, the user is given the option of performing these tests including, but not limited to ten coin tests, via the present invention. In one embodiment, the user simply drops ten coins and one bill into the gaming machine and, with the data entry system, indicates that the test has begun. This indication is communicated in real time to casino server 20 and the meter information at the time the test began is stored on database 22. After the expiration of the time period specified by the gaming regulations, the user uses the data entry system of handheld device 12 to indicate the test is completed. Again, this indication is communicated in real time to casino server 20 and the meter information at the time the test ended is stored on database 22. Through systems well known in the art, casino server 20 then retrieves the information stored on database 22 and generates a report indicating that the gaming machine is properly (or improperly) capturing and processing information.

Utilizing the present invention for conducting these tests is much less time consuming and easier for casino employees to administer than the prior art manual systems and methods for conducting these tests. In one prior art example, employees would use an employee computer terminal and its associated printer to print a screen shot of the meters before conducting the test, drop the money, open the gaming machine in order to get a meter reading for the end of the test, and again print the meter readings from when the gaming machine was opened. Thereafter, the casino employees had to manually generate the resulting report.

The present invention can be further modified within the scope and spirit of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A system for conducting casino business at any location within a casino comprising:
a host server comprising a memory;
a database associated with the memory;
data relative to the casino business retrievably stored in the memory in accordance with the database;
a handheld computing device capable of being transported to any location within the casino, the handheld computing device comprising a data entry system and a display system; and
a wireless communication system operably coupled between the host server and the handheld computing device, the wireless communication system configured for bi-directional communication of the casino business data between the host server and the handheld computing device.

2. A system for conducting casino business at any location within a casino comprising:
a host server comprising a memory;
a database associated with the memory;
data relative to the casino business retrievably stored in the memory in accordance with the database;
a handheld computing device capable of being transported to any location within the casino, the handheld computing device comprising a data entry system and a display system; and
a wireless communication system operably coupled between the host server and the handheld computing device, the wireless communication system configured to: (i) retrieve select casino business data from the host server in response to a request for that select casino business data input via the data entry system, and communicate the retrieved casino business data from the host server to the handheld computing device so that the retrieved casino business data can be displayed on the display system; (ii) communicate casino business data input via the data entry system to the host server so that the input casino business data can be retrievably stored in the memory in accordance with the database; and (iii) communicate a command input via the data entry system relative to the casino business data to the host server so that the host server can operate to complete the command.

3. The system of claim 2, wherein the wireless communication system comprises an ultrasonic communication system.

4. The system of claim 2, wherein the wireless communication system comprises an infrared communication system.

5. The system of claim 2, wherein the wireless communication system comprises a radio frequency communication system.

6. A system for conducting casino business at any location within a casino comprising:
a host server comprising a memory;
a database associated with the memory;
data about a plurality of customers of the casino retrievably stored in the memory in accordance with the database;
a handheld computing device capable of being transported to any location within the casino, the handheld computing device comprising a data entry system and a display system; and
a wireless communications system operably coupled between the host server and the handheld computing device, the host server and the wireless communication system configured to: (i) retrieve the customer data from the host server relative to a customer selected from the plurality of customers by entry of identification data about the customer via the data entry system; (ii) communicate the retrieved customer data relative to the selected customer from the host server to the handheld computing device so that the retrieved customer data relative to the selected customer can be displayed on the display system; and (iii) communicate new customer data relative to the selected customer input via the data entry system to the host server so that the new customer data can be retrievably stored in the memory in accordance with the database.

7. The system of claim 6 wherein the customer data comprises table game rating data.

8. The system of claim 6 wherein the customer data comprises comp data.

9. A system for conducting casino business at any location within a casino comprising:
a host server comprising a memory;
a database associated with the memory;
a handheld computing device capable of being transported to any location within the casino, the handheld computing device comprising a data entry system and a display system wherein a user of the handheld computing device may input enrollment data about a customer of the casino desiring to enroll in a customer loyalty program via the data entry system; and
a wireless communication system operably coupled between the host server and the handheld computing device, the wireless communication system configured to communicate the enrollment data input via the data entry system to the host server, the host server configured to retrievably store the enrollment data in the memory in accordance with the database.

10. A system for conducting casino business at any location within a casino comprising:
a host server comprising a memory;
a database associated with the memory;
comp data for a plurality of customers of the casino retrievably stored in the memory in accordance with the database, the comp data including comps available to the plurality of customers;
a handheld computing device capable of being transported to any location within the casino, the handheld computing device configured to issue comps based on the comp data, the handheld computing device comprising a data entry system and a display system; and
a wireless communication system operably connected between the host server and the handheld computing device, the host server and the wireless communication system configured to: (i) retrieve the comp data for a customer selected from the plurality of customers by entry of identification data about the customer via the data entry system from the host server; (ii) communicate the comp data relative to the selected customer from the host server to the handheld computing device so that the comp data relative to the selected customer can be displayed on the display system; and (iii) communicate a comp selected via the data entry system from the comps available to the selected customer and issued via the handheld computing device to the host server so that the issued comp can be retrievably stored in the memory in accordance with the database.

11. A method for conducting business at any location within a casino comprising the steps of:
providing a host server comprising a memory;
providing a database associated with the memory;
retrievably storing data relative to the casino business in the memory in accordance with the database;
providing a handheld computing device capable of being transported to any location within the casino, the handheld computing device comprising a data entry system and a display system;
establishing bi-directional wireless communication between the host server and the handheld computing device; and
communicating the casino business data between the host server and the handheld computing device.

12. A method for conducting casino business at any location within a casino comprising the steps of:
providing a host server comprising a memory;
providing a database associated with the memory;
retrievably storing data relative to the casino business in the memory in accordance with the database;
providing a handheld computing device capable of being transported to any location within the casino, the handheld computing device comprising a data entry system and a display system;
establishing wireless communication between the host server and the handheld computing device;
inputting a request for select casino business data via the data entry system;
retrieving the select casino business data from the host server in response to the request for the select casino business data;
communicating the retrieved casino business data from the host server to the handheld computing device;
displaying the retrieved casino business data on the display system;
inputting casino business data via the data entry system;
communicating the casino business data input via the data entry system to the host server;
retrievably storing the input casino business data in the memory in accordance with the database;
inputting a command via the data entry system relative to the casino business data; and
communicating the command to the host server, the host server completing the command.

13. The method of claim 12 wherein the step of establishing wireless communication between the host server and the handheld computing device is established with ultrasonic signals.

14. The method of claim 12 wherein the step of establishing wireless communication between the host server and the handheld computing device is established with infrared signals.

15. The method of claim 12 wherein the step of establishing wireless communication between the host server and the handheld computing device is established with radio frequency signals.

16. A method for conducting casino business at any location within a casino comprising:
providing a host server comprising a memory;
providing a database associated with the memory;
retrievably storing data about a plurality of customers in the memory in accordance with the database;
providing a handheld computing device capable of being transported to any location within the casino, the handheld computing device comprising a data entry system and a display system;
establishing wireless communication between the host server and handheld computing device;
selecting a customer from the plurality of customers by entering identification data about the customer via the data entry system;
retrieving the customer data relative to the selected customer from the host server;
communicating the retrieved customer data relative to the selected customer from the host server to the handheld computing device;
displaying the retrieved customer data relative to the selected customer on the display system;
inputting new customer data relative to the selected customer via the data entry system;
communicating the new customer data relative to the selected customer to the host server; and
retrievably storing the new customer data relative to the selected customer in the memory in accordance with the database.

17. The method of claim 16 wherein the customer data comprises table game rating data.

18. The method of claim 16 wherein the customer data comprises comp data.

19. A method for conducting casino business at any location within a casino comprising the steps of:
providing a host server comprising a memory;
providing a database associated with the memory;
providing a handheld computing device capable of being transported to any location within the casino, the handheld computing device comprising a data entry system and a display system;
establishing wireless communication between the host server and the handheld computing device;
inputting data enrollment data about a customer of the casino desiring to enroll in a customer loyalty program via the data entry system;
communicating the enrollment data from the handheld computing device to the host server; and
retrievably storing the enrollment data in the memory in accordance with the database.

20. A method for conducting casino business at any location within a casino comprising:
providing a host server comprising a memory;
providing a database associated with the memory;
retrievably storing comp data for a plurality of customers of the casino in the memory in accordance with the database, the comp data including comps available to casino customers;
providing a handheld computing device capable of being transported to any location within the casino, the handheld computing device comprising a data entry system and a display system;
establishing wireless communication between the host server and the handheld computing device;
selecting a customer from the plurality of customers by entering identification data about the customer via the data entry system;
retrieving the comp data relative to the selected customer from the host server;
communicating the comp data relative to the selected customer from the host server to the handheld computing device;
displaying the comp data relative to the selected customer on the display system;
selecting a comp via the data entry system from the comps available to the selected customer;
issuing the selected comp via the handheld computing device;
communicating the issued comp to the host server; and
retrievably storing the issued comp in the memory in accordance with the database.
